(19) United States
(12) Patent Application Publication
(10) Pub. No.: US 2006/0010017 A1
(43) Pub. Date: Jan. 12, 2006

(54) Method and system for simulating order processing processes, corresponding computer program product, and corresponding computer-readable storage medium

(75) Inventors: Stephan Hase, Magdeburg (DE); Jan Hickmann, Wolfsburg (DE); Ulrich Wendt, Braunschweig (DE); Axel Wagenitz, Bremen (DE)

Correspondence Address: NORRIS, MCLAUGHLIN & MARCUS, P.A., 875 THIRD AVE, 18TH FLOOR, NEW YORK, NY, 10022, US

(73) Assignees: VOLKSWAGEN Aktiengesellschaft, Wolfsburg (DE); FRAUNHOFFER- Gesellschaft zur Forderung der angewa, Munchen (DE)

(21) Appl. No.: 10/519,510

(22) PCT Filed: Jun. 6, 2003
(86) PCT No.: PCT/EP03/06025

§ 371 Date: Sep. 2, 2005

(30) Foreign Application Priority Data
Jun. 25, 2002 (DE) 102 28 358.3
Jan. 17, 2003 (DE) 103 02 433.6

(51) Int. Cl. G06Q 90/00

(52) U.S. Cl. 705/7

(57) ABSTRACT

The invention relates to a method for simulating order processing processes used for producing a complex product, particularly a motor vehicle, and a simulation system, a corresponding computer program product, and a corresponding computer-readable storage medium. The inventive method comprises the following steps: a) requirement figures for at least one class of the product are entered into a data processing device for at least one predefined period of time; b) said requirement figures are automatically adjusted to predefined sets of data describing production capacities and/or (production-)supply capacities by means of a computer program that is installed on the data processing device; c) the requirement figures or portions thereof are assigned to production sites (factories); d) the production and/or supply for the production is simulated based on the assignment done in step c); e) the distribution paths are automatically determined and the distribution(s) of finished products from the factories to the delivery locations is/are simulated; f) at least some of the data generated in steps a) to e) is stored and/or output.

The invention relates to a method and a simulation system for simulating order processing processes for producing a complex product, in particular a motor vehicle, and to a corresponding computer program product and a corresponding computer-readable storage medium with the features recited in the preamble of claims 1, 16, and 18 to 21.

Over the years, attempts were made to improve production processes in several industries, in particular in the automotive industry. One approach to improve production processes includes the use of simulation models for planning and/or testing of systems and, more particularly, of flows of material. For this purpose, a large assortment of tools has been created, which in the meantime have become available as standard software.

This approach has since been expanded to include potential processes which include an interaction between several sub-processes, by also taking into consideration the rules controlling the processes. However, this approach results in a complex behavior which cannot be solved with conventional instruments and methods.

Conventional methods and tools for simulating material flow also are no longer sufficient to achieve the required transparency in such linked processes. For this reason, new tools are required.

The evaluation of business processes in the automotive industry is very demanding for several reasons. One of the reasons is that in many sub-processes the product “vehicle” does not achieve the objective without also representing the features (equipment), because these features have a strong impact on the process flow.

These features must also be considered when evaluating business processes by, on one hand, simulating the behavior of the customer in certain markets and, on the other hand, by considering a number of rules when assembling the vehicles.

Such detailed product representation becomes necessary because planning algorithms operate based on parts and/or equipment, so that only a “realistic” product representation enables conclusions about the efficiency of the process.

Complex business processes are difficult to design and/or evaluate with conventional methods. Possibilities for simulating these processes are limited, because conventional simulations are frequently performed based on rather abstract product and process representations.

As mentioned above, it can be shown that at least in the automotive industry, the conclusions quickly become inadequate when process and/or product details are abstracted. For example, when corporate processes are improved by transgressing the boundaries of previously weakly coupled individual business areas, such weak coupling can frequently be strengthened in integrated planning processes. For example, inventory in buffer zones between areas can be minimized. However, a reduction of the buffer zones not only results in the desired inventory reduction, but can also make the process more susceptive to disruptions. Until now, such effects could not be simulated and reliably estimated in advance.

The design of comprehensive processes, for example the described order processing process, is susceptive to high risk without supporting tools. Lack of transparency almost inevitably results in inefficient processes. Minimizing these risks requires a system which enables a process planner, from the first design to implementation, to qualitatively and/or quantitatively evaluate the effect of the planned processes and to possibly develop alternative process flows on that basis.

In particular, to continue with an example from the automotive industry, the conventional tools are not capable of representing the complex interdependencies of a vehicle's equipment. Accordingly, no tools are available to create models of vehicles, where these interdependencies are correctly taken into consideration (buildable vehicles).

It has also not been possible to this date to qualitatively and quantitatively evaluate a conversion of planning processes for factory posting, capacity control, disruption management, and the like, and/or alternative planning methods.

It has also not been possible to this date to qualitatively and/or quantitatively evaluate effects of planned processes and to possibly design alternative process flows on that basis.

It is therefore an object of the invention to provide a method and a simulation system for simulating order processing processes for producing a complex product, in particular a motor vehicle, as well as a corresponding computer program product and a corresponding computer-readable storage medium, which obviate the aforementioned disadvantages and, more particularly, enable comprehensive modeling and simulation of all planning processes in the logistics supply chain.

The object is solved by the invention by the features in the characterizing portion of claims 1, 16, and 18 to 21 in conjunction with the features in the preamble. Advantageous embodiments of the invention are recited in the dependent claims.

A particular advantage of the method of the invention for simulating order processing processes used for producing a complex product, in particular a motor vehicle, is the viability of comprehensively modeling and simulating all planning processes in the logistics supply chain, by performing the following steps:
a) entering into a data processing device demand quantities for at least one class of the product for at least one predefined period of time,
b) automatically adjusting, through use of a computer program installed on the data processing device, the demand quantities with predefined datasets that describe manufacturing capacities and/or (manufacturing) supplier capacities,
c) automatically allocating the demand quantities or portions of the demand quantities to production sites (factories),
d) simulating the production and/or supply for the production based on the allocation in step c),
e) automatically determining the distribution channels and simulating the distribution(s) of the finished products from the factories to the delivery locations,
f) storing and/or outputting at least a portion of the data generated in steps a) through e).

A simulation system for simulating order processing processes used for producing a complex product, in particular a motor vehicle, advantageously includes the modules “Forecast”, “Assumptions”, “Firm Orders”, “Production”, and “Distribution”, wherein the modules cooperate under the control of a computer program implemented on a computer system so that the following steps can be performed:
a) entering into a data processing device demand quantities for at least one class of the product for at least one predefined period of time,
b) automatically adjusting, through use of a computer program installed on the data processing device, the demand quantities with predefined datasets that describe manufacturing capacities and/or (manufacturing) supplier capacities,
c) automatically allocating the demand quantities or portions of the demand quantities to production sites (factories),
d) simulating the production and/or supply for the production based on the allocation in step c),
e) automatically determining the distribution channels and simulating the distribution(s) of the finished products from the factories to the delivery locations,
f) storing and/or outputting at least a portion of the data generated in steps a) through e).

According to an advantageous embodiment of the simulation system, the simulation system can include interfaces to databases of real systems, such as databases of dealers and/or production sites.

A computer program product for simulating order processing processes used for producing a complex product, in particular a motor vehicle, includes a computer-readable storage medium for storing a program which enables a computer, after the program is loaded into the memory of the computer, to execute a process for simulating order processing processes for producing a complex product, in particular a motor vehicle, wherein the simulation includes the process steps according to one of the claims 1 to 15.

For simulating order processing processes used for producing a complex product, in particular a motor vehicle, a computer-readable storage medium is advantageously used which stores a program that enables a computer, after the program is loaded into the memory of the computer, to execute a process for simulating order processing processes for producing a complex product, in particular a motor vehicle, wherein the simulation includes the process steps according to one of the claims 1 to 15.

Of particular advantage is the use of a method for simulating order processing processes according to one of the claims 1 to 15 or of a simulation system according to one of the claims 16 or 17 for determining planning data, such as optimization potentials, decision alternatives, performance figures for delivery times or delivery reliability, utilization of transportation means, costs, and the like.

It is also advantageous, when making strategic, tactical and/or operational decisions, to be able to use planning data, such as optimization potentials, decision alternatives, performance figures for delivery times or delivery reliability, utilization of transportation means, costs, and the like, which are provided by a method for simulating order processing processes according to one of the claims 1 to 15 or by a simulation system according to one of the claims 16 or 17.

According to an advantageous embodiment of the invention, the data sets used in the automatic adjustment of the demand quantities in step b) can include restrictions of production sites and/or suppliers.

According to another advantageous embodiment of the invention, the demand quantities in step a) of claim 1 are determined by defining a first demand forecast for a first forecast time period, determining a second demand forecast for a second forecast time period with stochastic processes from the first forecast, and determining the demand quantities according to definable algorithms which evaluate the first and/or second demand forecast.

Advantageously, the automatic adjustment in step b) of claim 1 can include a correction of the demand quantities for matching them to the manufacturing capacities and/or (manufacturing) supply capacities.

According to another advantageous embodiment of the method according to the invention, the process steps a) to c) of claim 1 include the following steps:
defining preliminary demand numbers (demand forecast) for a first forecast time period, preferably for a year of sales,
generating by simulation dealer orders for a second forecast time period, preferably for three months,
evaluating the preliminary demand numbers and dealer orders and determining an updated demand forecast for the second demand time period,
matching the updated demand forecast for the second demand time period to the capacities of the production sites and/or the suppliers, and determining approved firm order allocations and/or modular allocations,
generating the demand numbers (assumptions) for the defined time period, preferably a delivery week, by evaluating the approved firm order allocations, modular allocations and/or simulated buyer orders newly received by the dealers,
adjusting these demand numbers (firm orders) with respect to restrictions (capacity, utilization and the like) of the production site(s) and/or suppliers, and allocating the demand numbers (assumptions) to the production site(s).

According to another advantage of the method of the invention, in the automatic allocation of the demand numbers to the production sites, the demand numbers of the defined time period can be distributed across the allocated daily orders, or the automatic allocation of the demand numbers to the production sites can include compiling daily schedules for the production sites, or breaking up the products specified in the allocated daily orders into their modules.

Advantageously, the demand numbers can include information about significant equipment features of the products (“heavy items”).

According to another advantageous embodiment of the method of the invention, the model on which the simulation is based can represent several production sites, and/or the model on which the simulation is based can include parameters characterizing a production site, such as capacity limitations, work schedule models, and/or permanent staff. The model on which the simulation is based can also differentiate between dealers, in particular between dealers of the domestic market and importers, and/or allows the distribution channels to be subdivided into distribution sub-channels.

Advantageously, with the method of the invention, the data generated in steps a) to e) of claim 1 can include quantitative evaluations of process designs, assessments of strategies, for example with respect to disruption management, dates for freezing orders, delivery times, delivery reliability, utilization of transportation means and/or costs.

Advantageously, data from databases of real systems, in particular from databases of dealers and/or production sites, can also be automatically evaluated during the process.

The advantages associated with the application of the simulation model of the invention in planning and operation can be summarized as follows:
validation of the planned order processing process before implementation,
improved planning of the order processing process before implementation as well as during the operational phase through construction and evaluation of different scenarios in an experimental setting,
analysis and evaluation of potential weak points, for example, answering an exemplary question, such as: Which locations cause unnecessarily long processing times and which are the boundary condition responsible for these delays?
supporting the generation of a process description for the development of planning and control instruments,
testing of decision margins and performance limits in extreme situations (overloading, interruptions, etc.) and deriving possible compensation strategies as preventative measures.

Application of the method or simulation system of the invention has the following additional advantages:
1. A product model is included in the invention, by which the complicated interdependencies of vehicle equipment can be represented in form of rules. As a result, vehicle models can be generated which satisfy these rules (buildable vehicles).
2. The detailed conversion of planning methods for factory posting, capacity control, disruption management, and the like is enabled. Alternative planning methods can be evaluated qualitatively and quantitatively.
3. Almost any segment of the OTD process (OTD=Order to Delivery) can be modeled, modified, and its effect on the entire process can be investigated.
4. Operative systems can be integrated whereby the effects of decisions can be investigated before implementation based on actual data.

The method of the invention integrates and expands concepts from material flow simulation, business process simulation, and systems of the Supply Chain Management (SCM). The method of the invention is based on the discrete, detailed, event-controlled simulation of business processes with respect to product cancellation, planning algorithms, and visualization range. This result can advantageously also be used in logistics.

With the invention, important planning processes affecting the entire logistics supply chain are modeled for the product representation and the order processing process. One particular advantage attainable with the invention is the high quality of the results, which makes it possible to support the introduction of new processes on a strategic, tactical and operative level. In this way, all planning processes in the logistic supply chain can be modeled and simulated comprehensively, enabling the construction of complex models.

Only the high quality of the results makes it possible to use the invention through the entire process, from process design to operative implementation:
on a strategic level: process designs can be quantitatively evaluated.
on a tactical level: evaluation of strategies, for example for disruption management, becomes possible.
on an operative level: planners can evaluate production programs with respect to their effects on delivery time, delivery reliability, utilization of transport means and/or also costs.

In addition to adding reliability to the process design, the number of other advantages arise:
system loads can be efficiently generated based on complex control mechanisms
buffers between process steps can be dimensioned based on reliable results
the order processing process can be evaluated in its entirety, as well as in its partial aspects
planning algorithms (demand and capacity management, disruption management, procurement, etc.) can be investigated and evaluated.
the formulation of planning methods is unique. The simulation model can serve as a reference.
the process design is supported consistently from the first design, through implementation of IT systems, to the functional operation.

The invention enables a comprehensive evaluation of processes, so that new optimization potentials can be attempted and implemented with a very low risk for the company.

Additional advantageous embodiments of the invention include additional features recited in the dependent claims.

Exemplary embodiments of the invention will be described below in more detail with reference to the corresponding drawings. It is shown in:

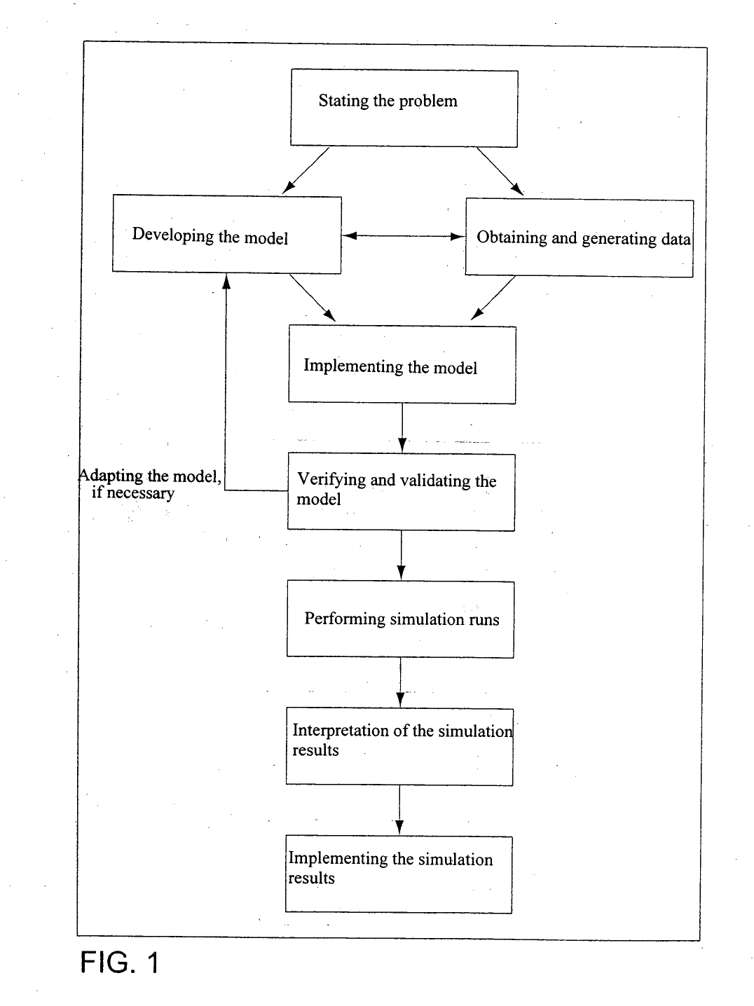

FIG. 1 a flow diagram of a simulation study;

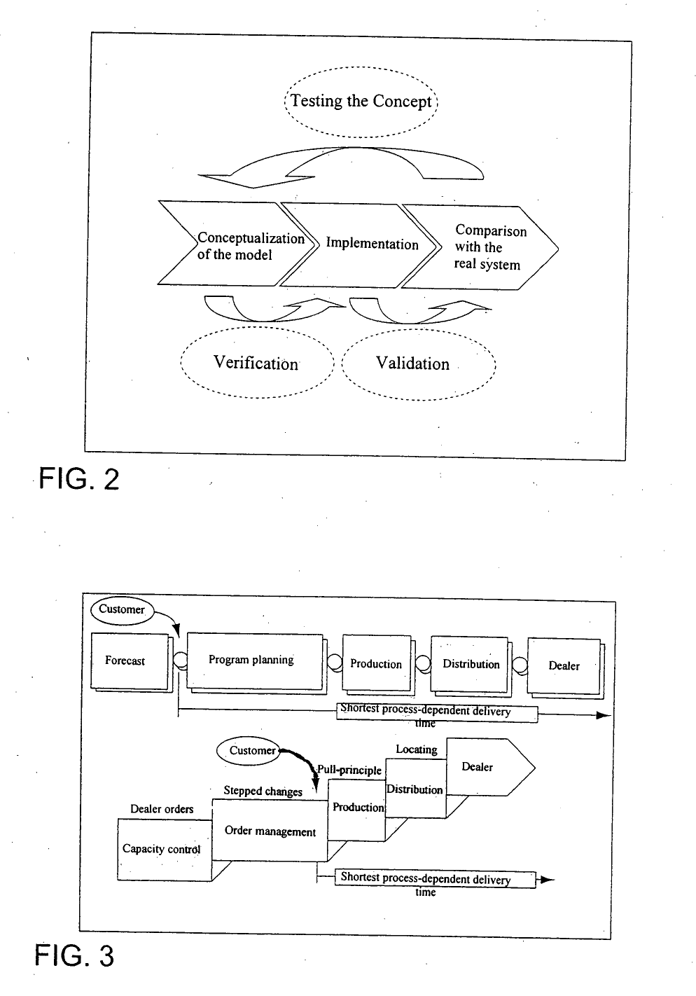

FIG. 2 a verification and validation of simulation models;

FIG. 3 a comparison between a sequential and a simultaneous process architecture;

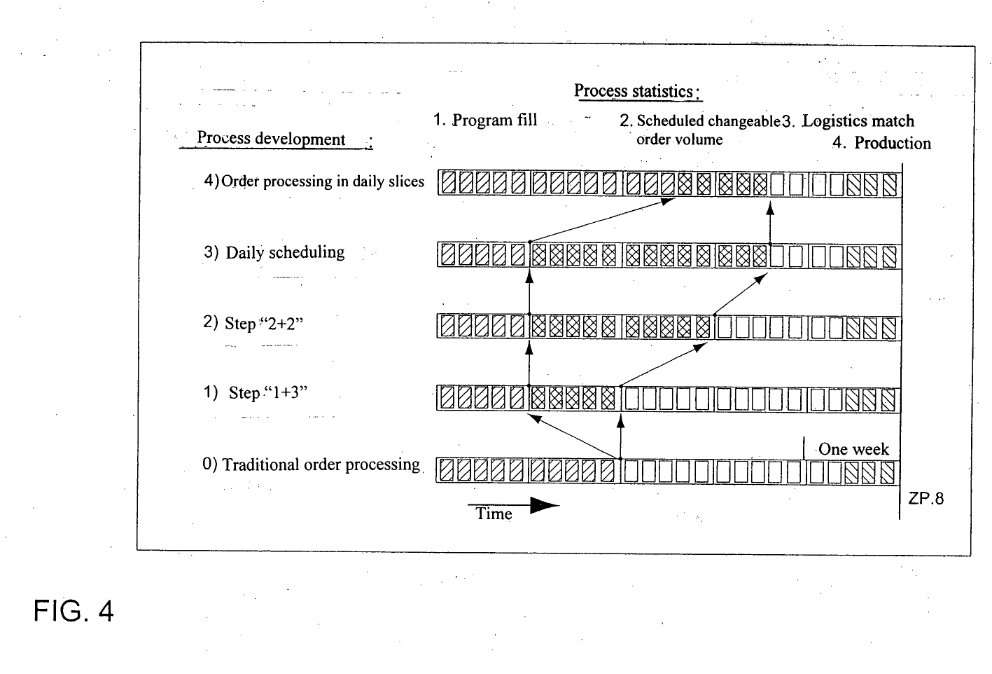

FIG. 4 an illustration of possible process steps in the implementation of the daily schedule;

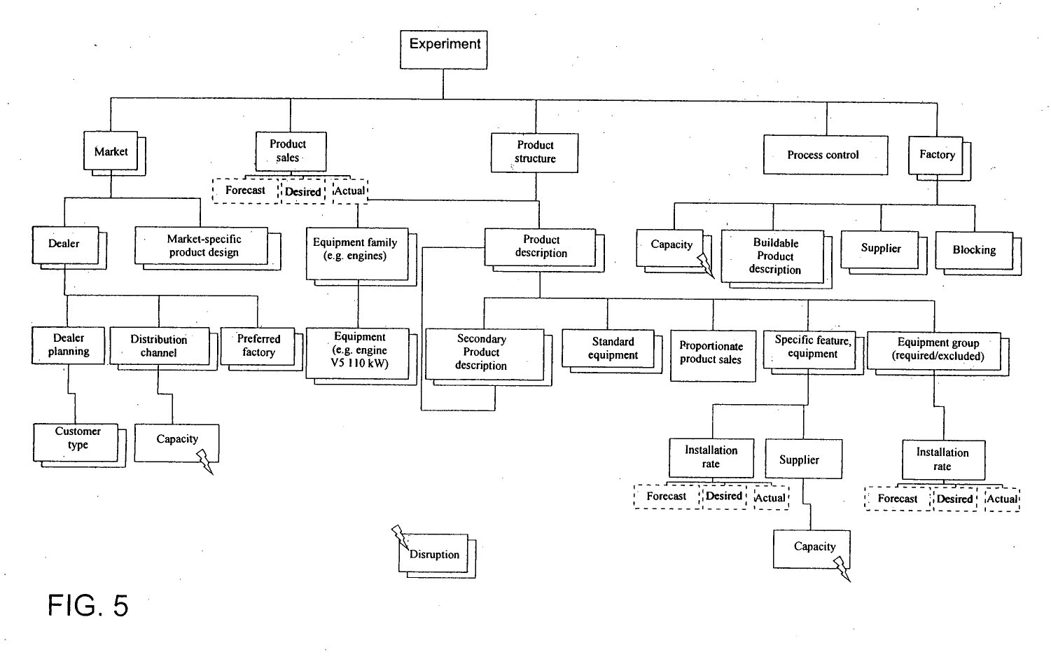

FIG. 5 an example for a possible structure of a model for simulating the order processing process;

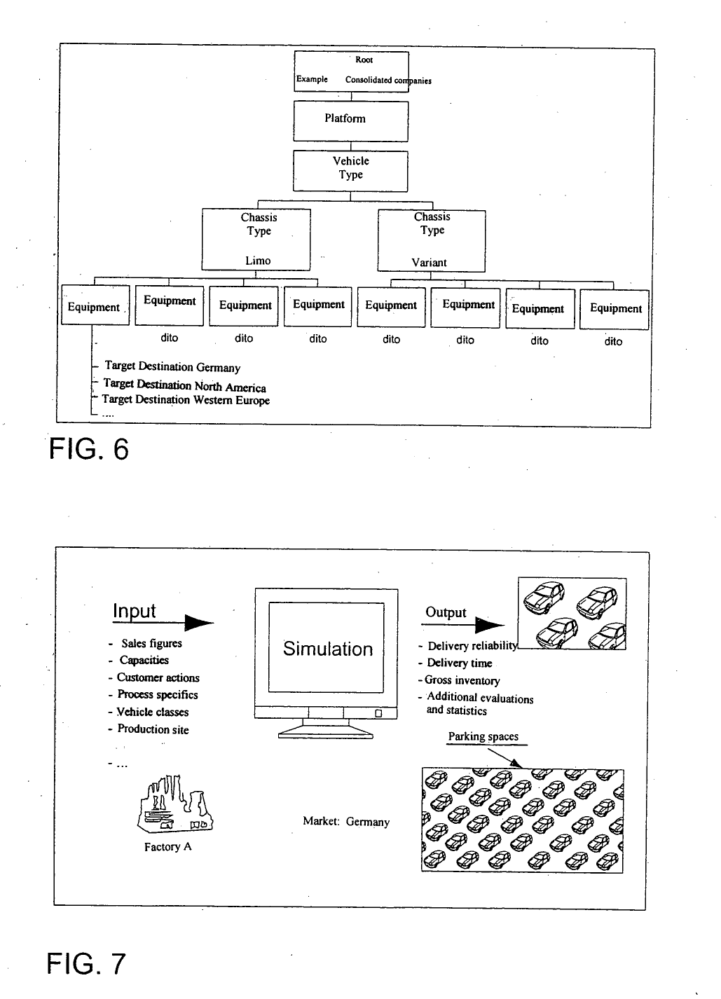

FIG. 6 an exemplary diagram of levels of the vehicle type;

FIG. 7 a diagram of input and output data of a simulation study for the model “vehicle delivery to a delivery site of the manufacturer(s)”;

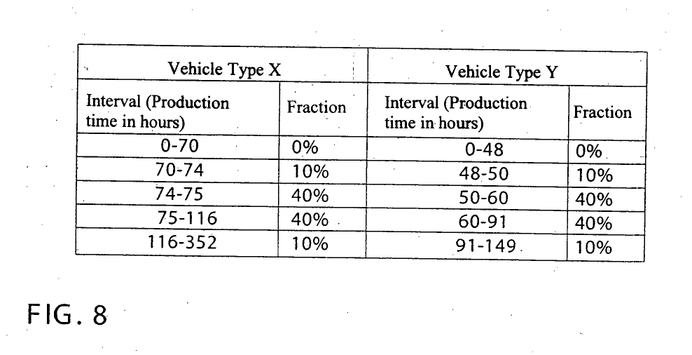

FIG. 8 a distribution of the production cycle times for the vehicle types X and Y;

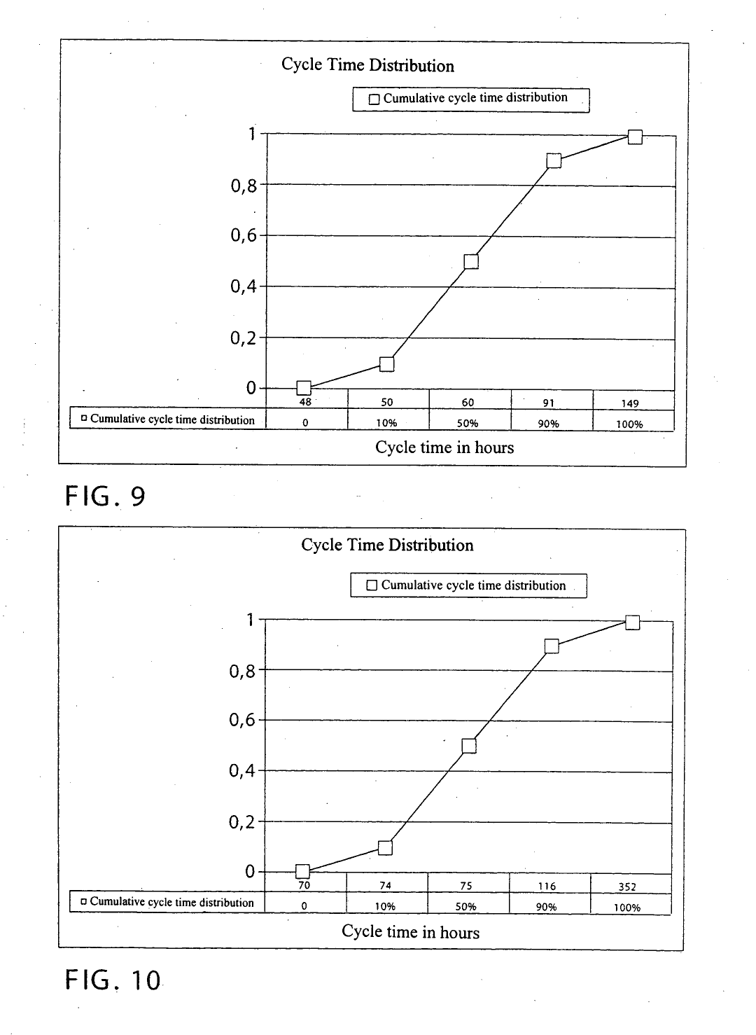

FIG. 9 a diagram of the actual production cycle time for the vehicle type Y;

FIG. 10 a diagram of the actual production cycle time for the vehicle type X;

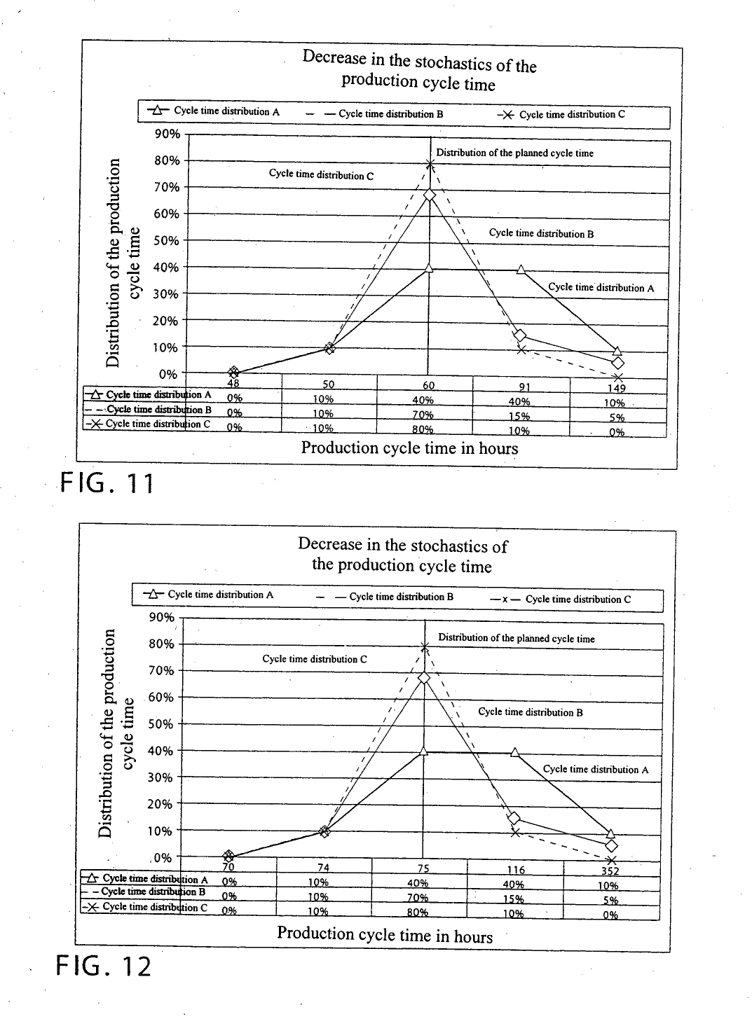

FIG. 11 an illustration of the decrease of the stochastic in the production cycle time of the vehicle type Y;

FIG. 12 an illustration of the decrease in the stochastics in the production cycle time of the vehicle type X;

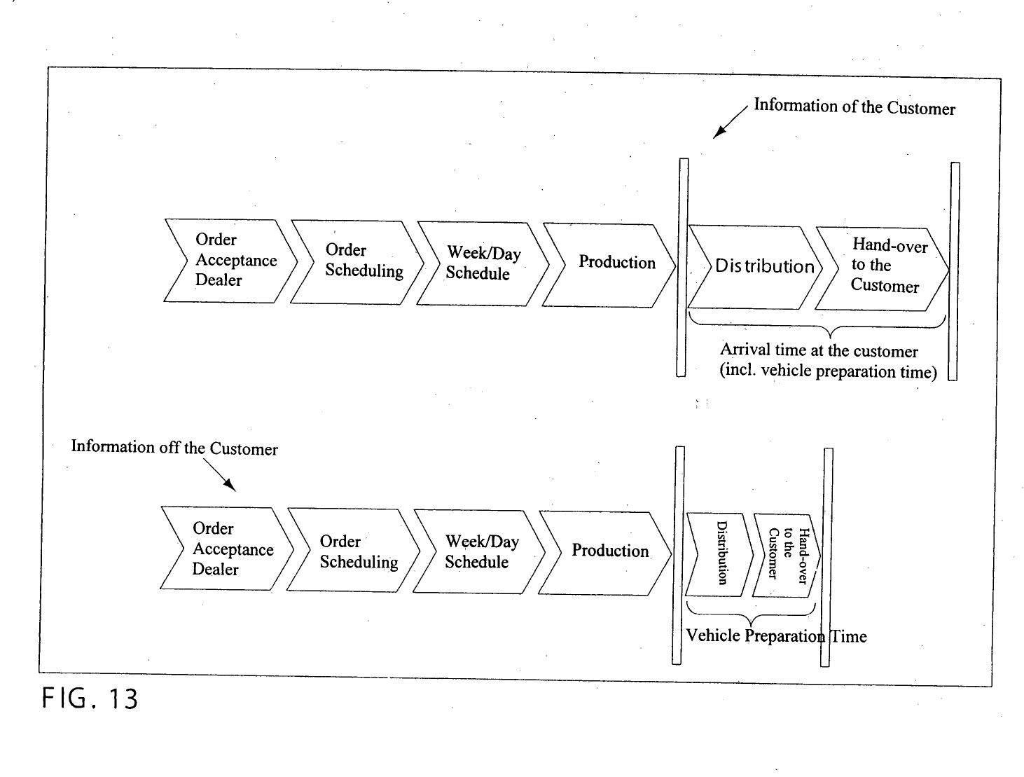

FIG. 13 a comparative diagram the arrival time at a customer in a scenario, where the customer is informed of the delivery date only after completion of the vehicle (top), and a scenario, where the customer is informed of the delivery date already during the vehicle planning stage (bottom);

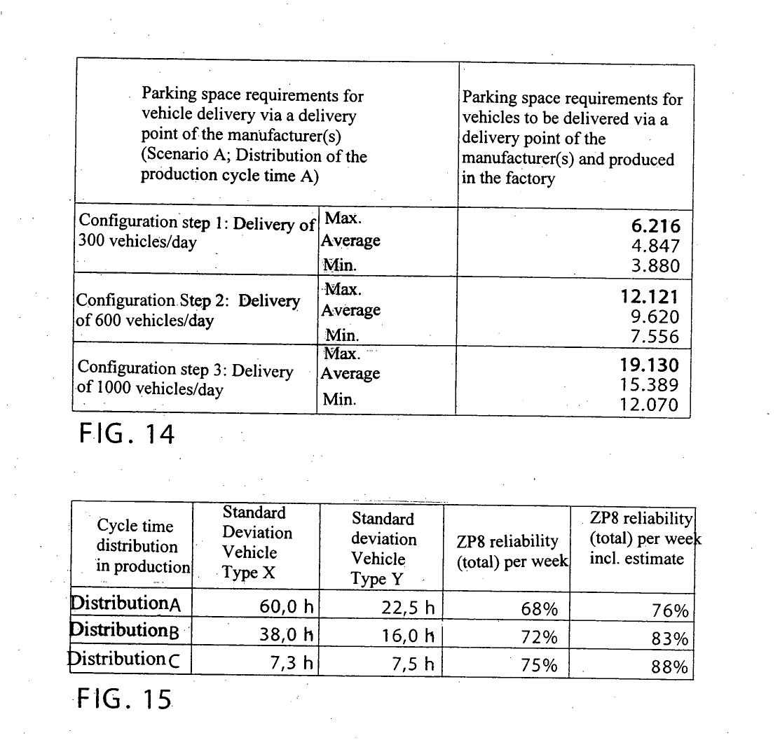

FIG. 14 a table of the required parking space during the vehicle delivery to a delivery site of the manufacturer(s);

FIG. 15 a table with the results of the sensitivity analysis;

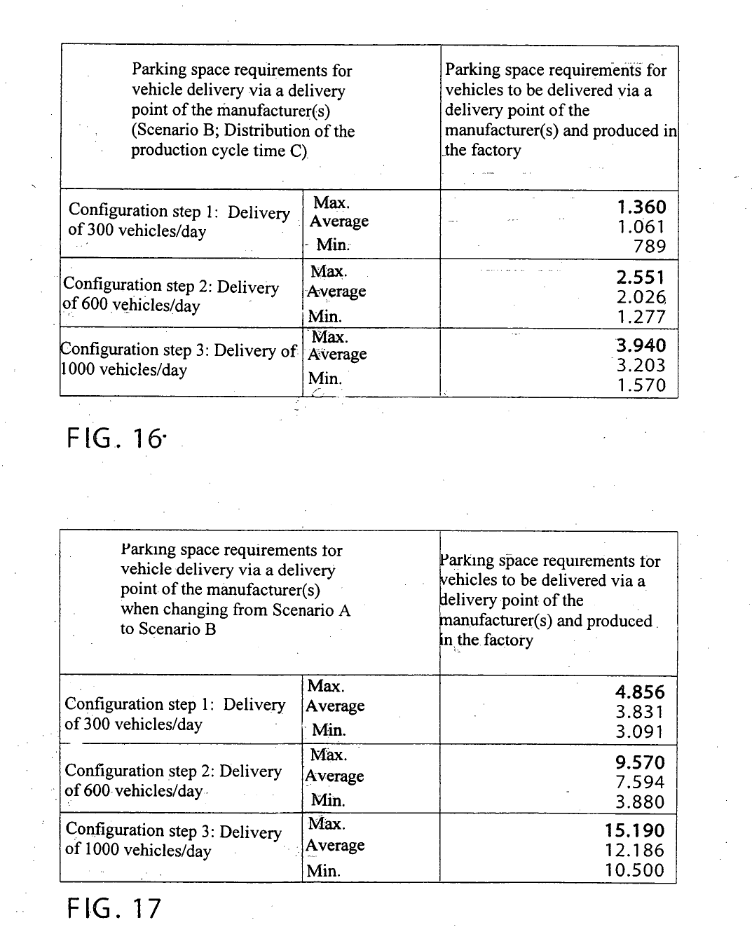

FIG. 16 a table of the required parking space for the scenario S2 and the distribution Vc of the production cycle time;

FIG. 17 a table of the savings potential for parking spaces when changing from scenario S1 to scenario S2;

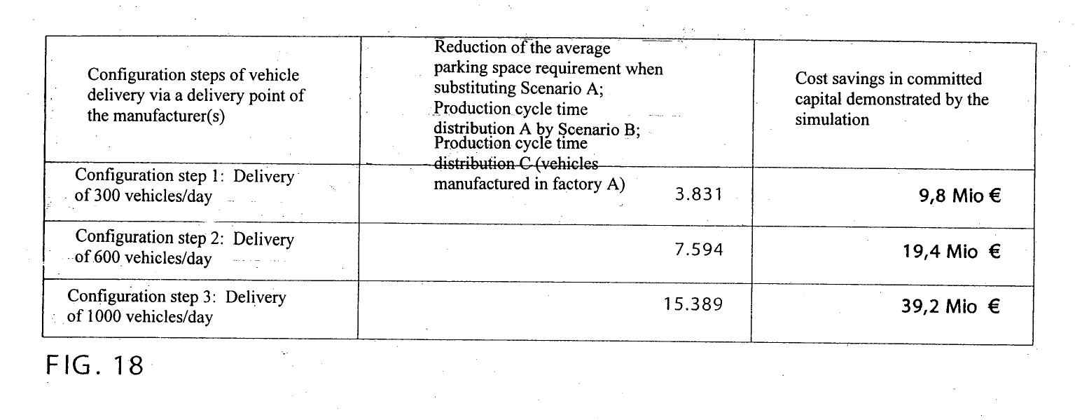

FIG. 18 a table with information about a reduction in the capital commitment costs per year when changing from scenario S1 with a distribution Va of the production cycle time to scenario S2 with a distribution Vc of the production cycle time;

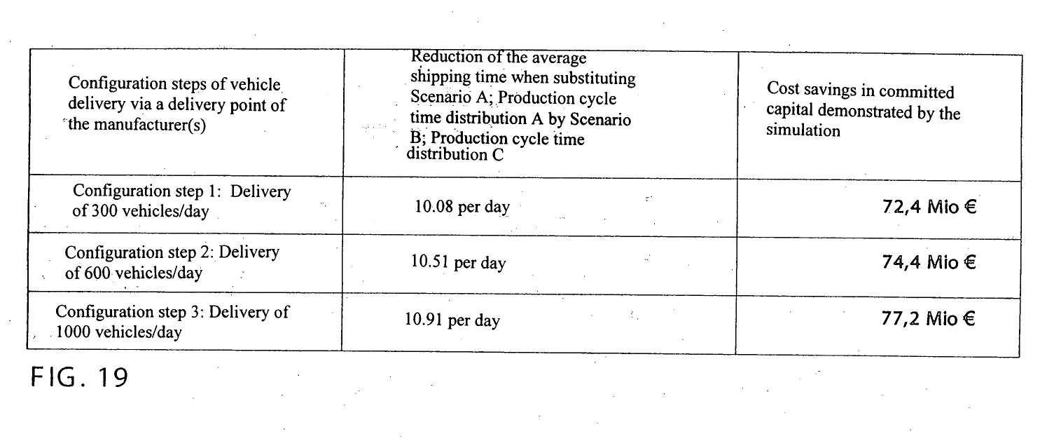

FIG. 19 a table with information about a reduction in the capital commitment costs per vehicle when changing from scenario S1 with a distribution Va of the production cycle time to scenario S2 with a distribution Vc of the production cycle time;

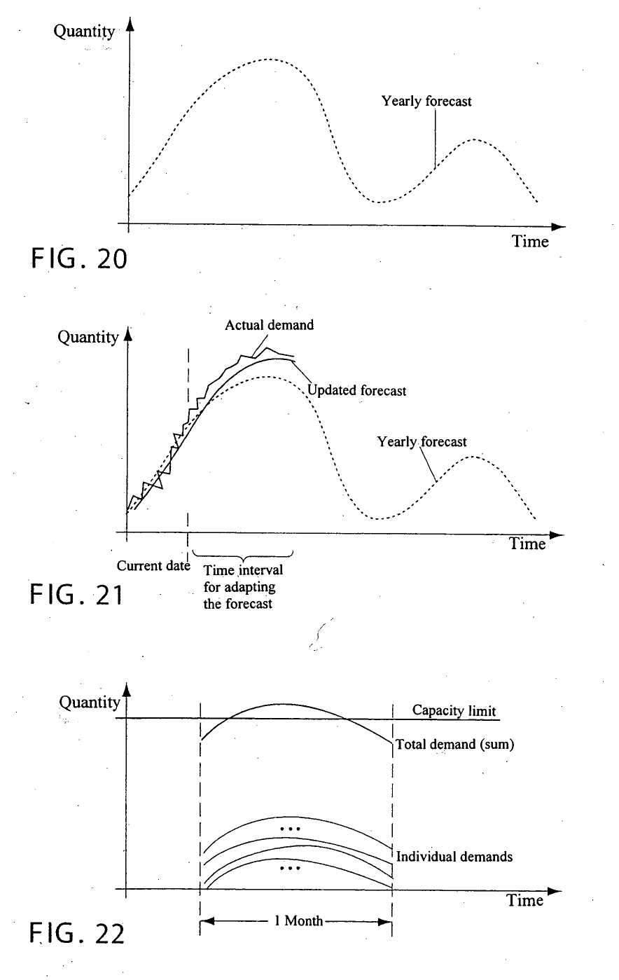

FIG. 20 a schematic diagram of a yearly forecast;

FIG. 21 a schematic diagram of a forecast update;

FIG. 22 a schematic diagram of a capacity adjustment;

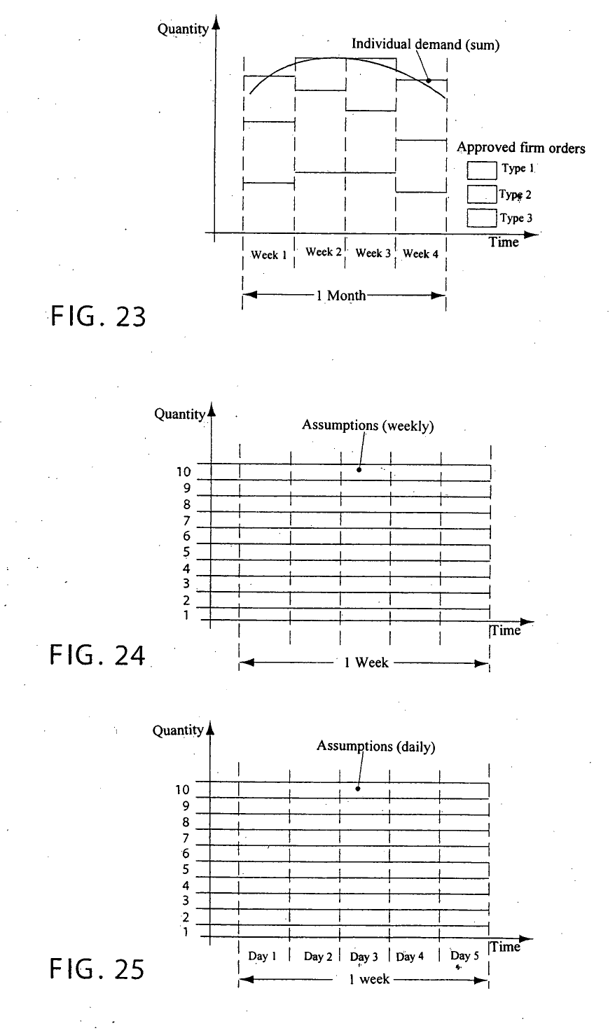

FIG. 23 a schematic diagram of the generation of “approved firm orders”;

FIG. 24 a schematic diagram of the “weekly assumptions”;

FIG. 25 a schematic diagram of the “daily assumptions”;

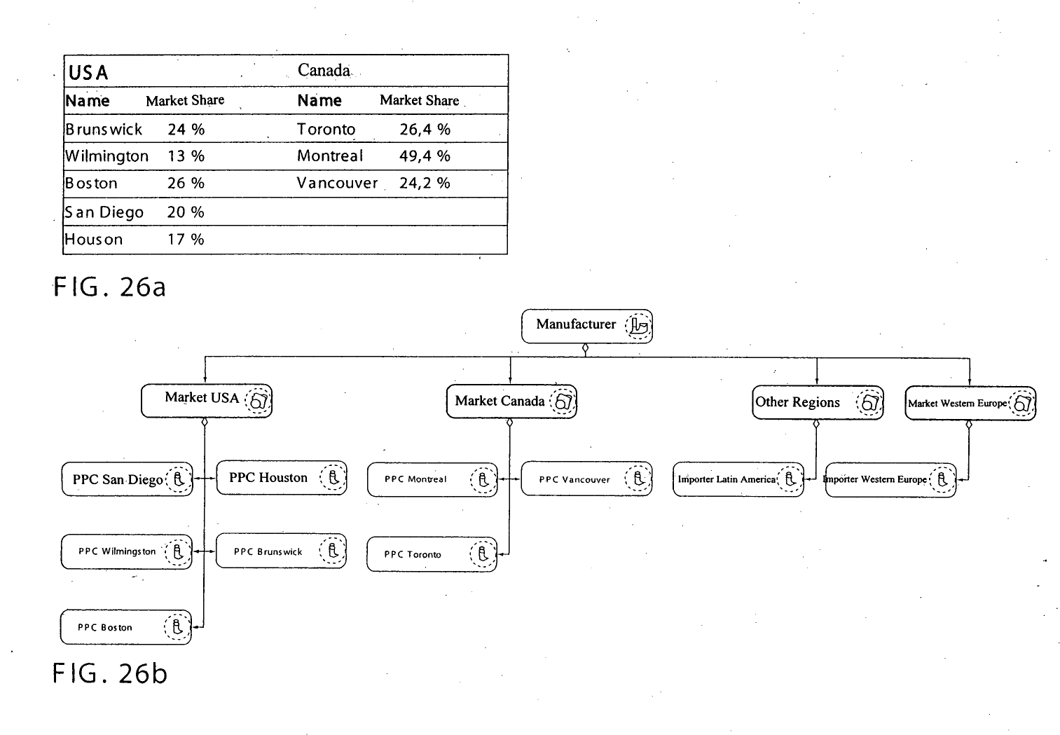

FIG. 26a an exemplary embodiment of the market structure for the USA and Canada;

FIG. 26b an exemplary diagram of the markets and dealers;

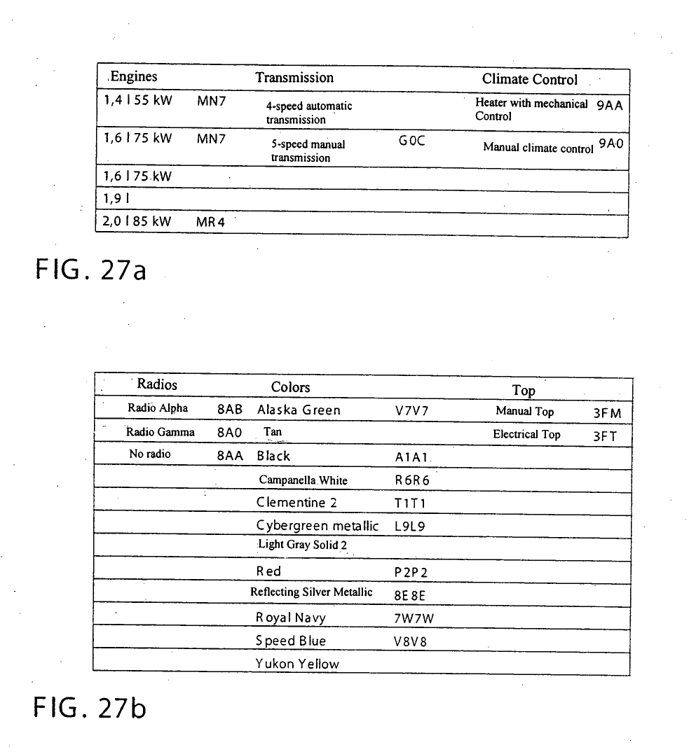

FIG. 27a PR number families for engines, transmissions and climate control;

FIG. 27b PR number families for radios, colors and top;

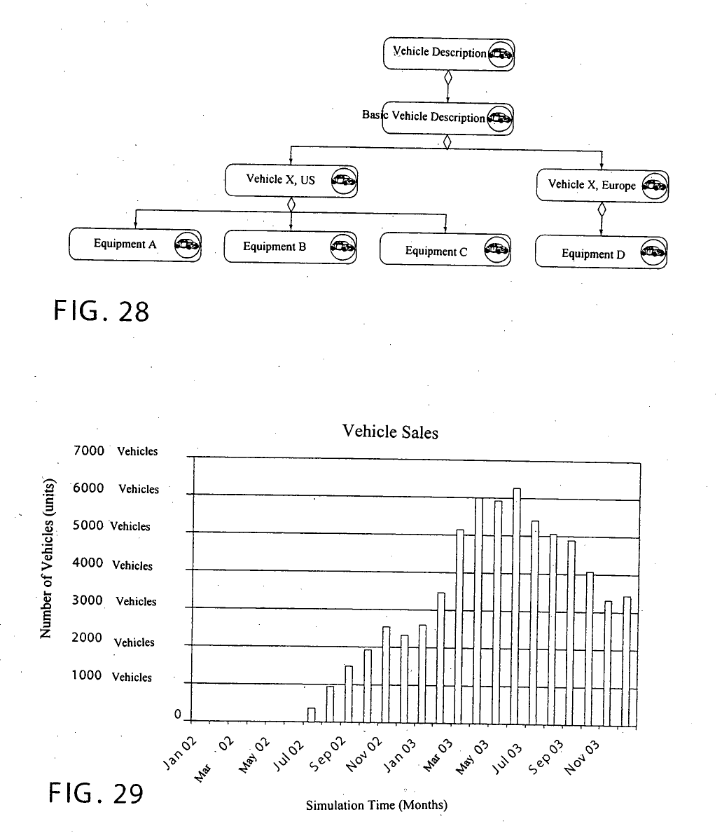

FIG. 28 a diagram of a product tree;

FIG. 29 an exemplary diagram for illustrating the projected sales for the vehicle X;

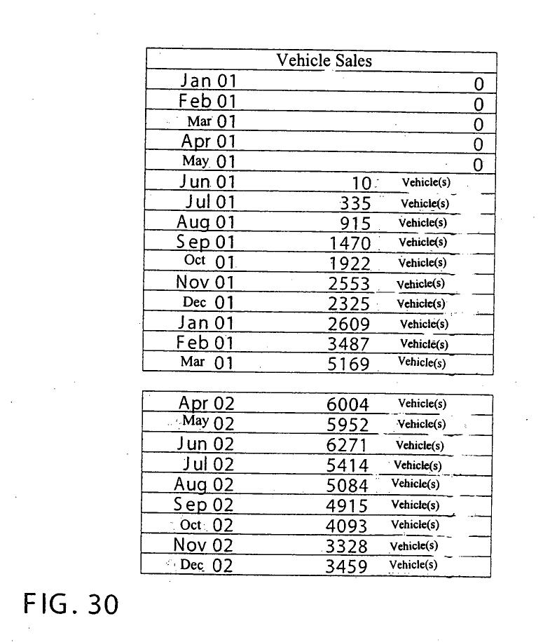

FIG. 30 sales data providing the basis for the diagram shown in FIG. 29;

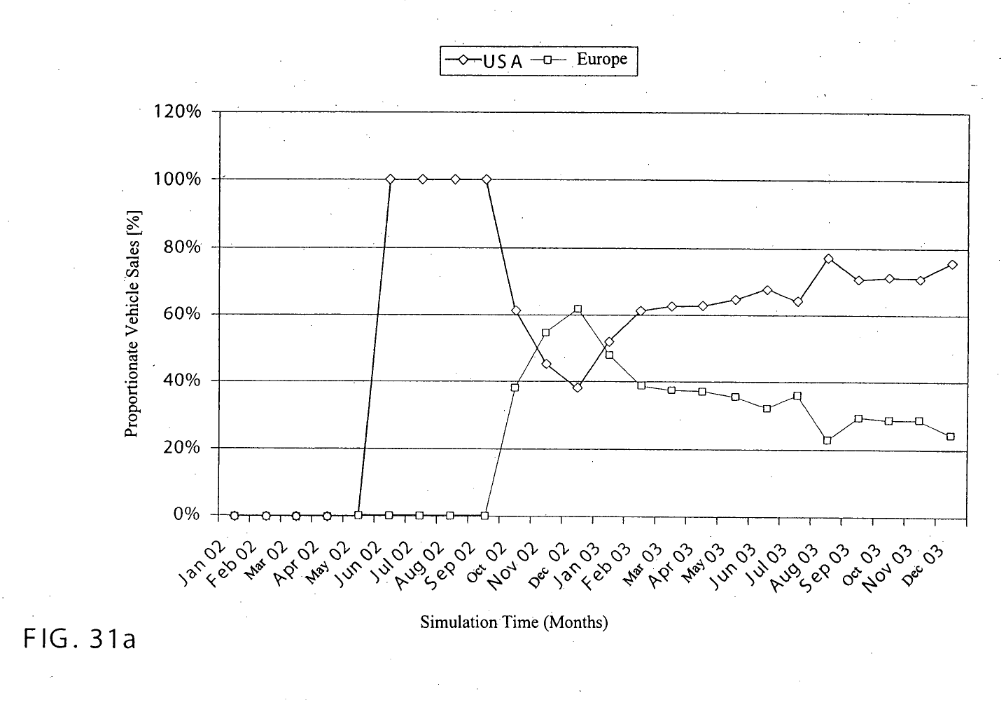

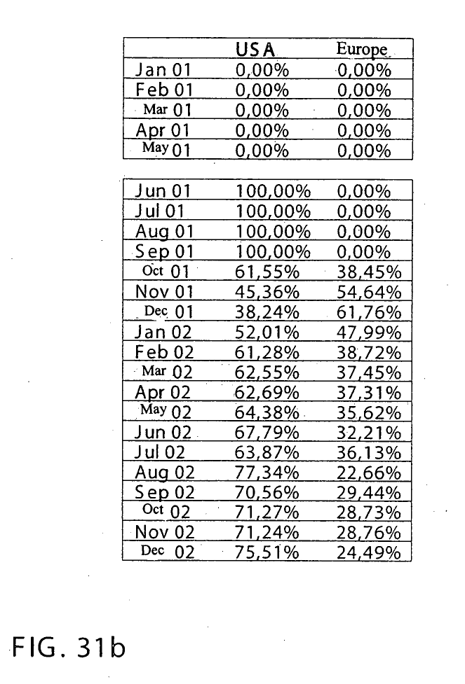

FIG. 31 a a diagram with the prorated vehicle sales for North America and Europe used in one embodiment;

FIG. 31b the sales data on which the diagram of FIG. 31 a is based;

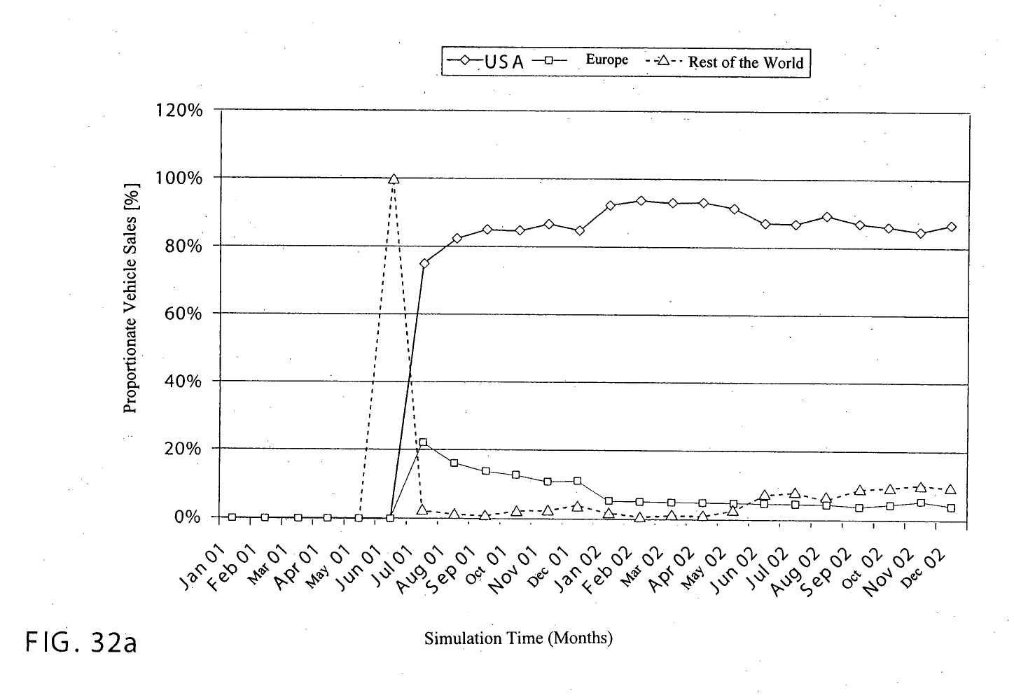

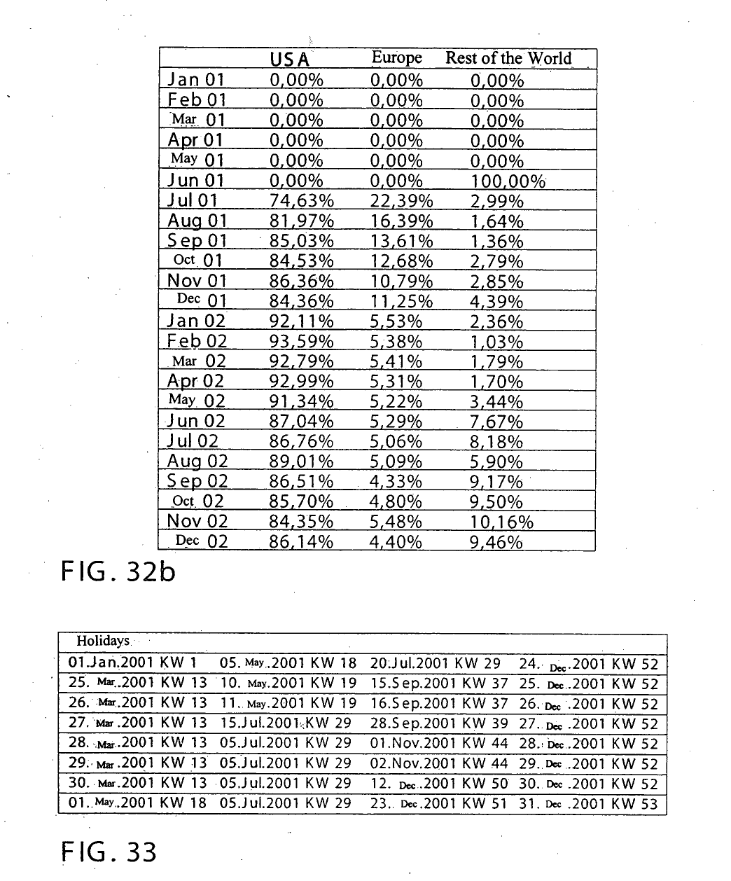

FIG. 32a a diagram with the prorated vehicle sales for North America, Europe, and “other regions” used in one embodiment;

FIG. 32b the sales data on which the diagram of FIG. 32a is based;

FIG. 33 in one embodiment, a table with days off in factory A;

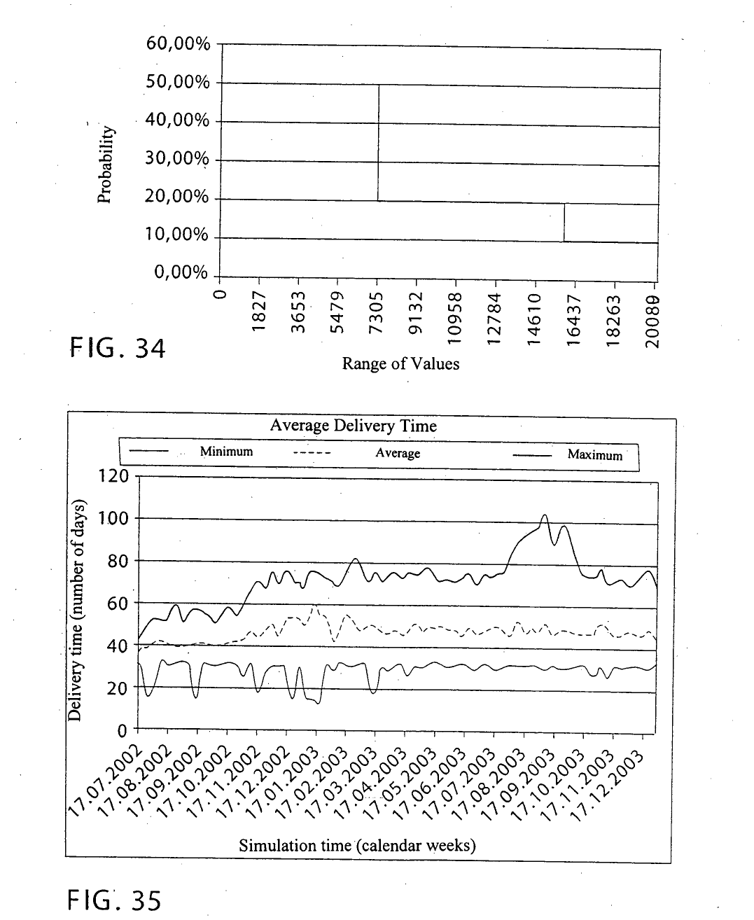

FIG. 34 in one embodiment, a probability distribution for the mix when generating a daily program;

FIGS. 35 to 42 results of the simulation with an exemplary basic model:

FIG. 35 average, minimum and maximum delivery time;

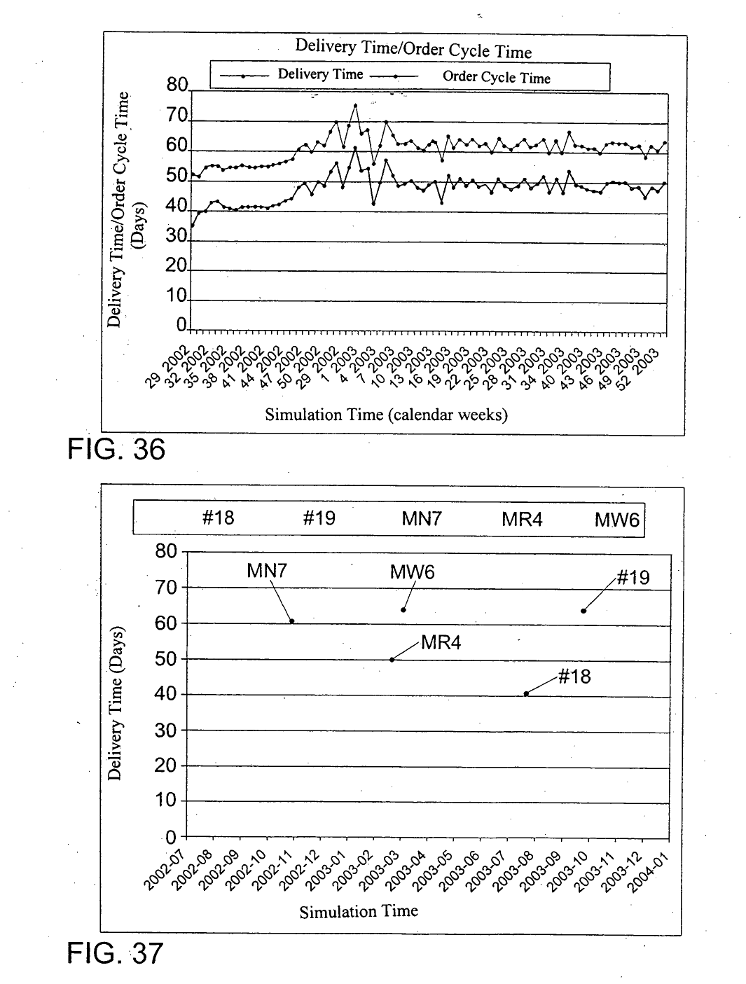

FIG. 36 average delivery cycle and order cycle time;

FIG. 37 delivery time for vehicles with a certain engine;

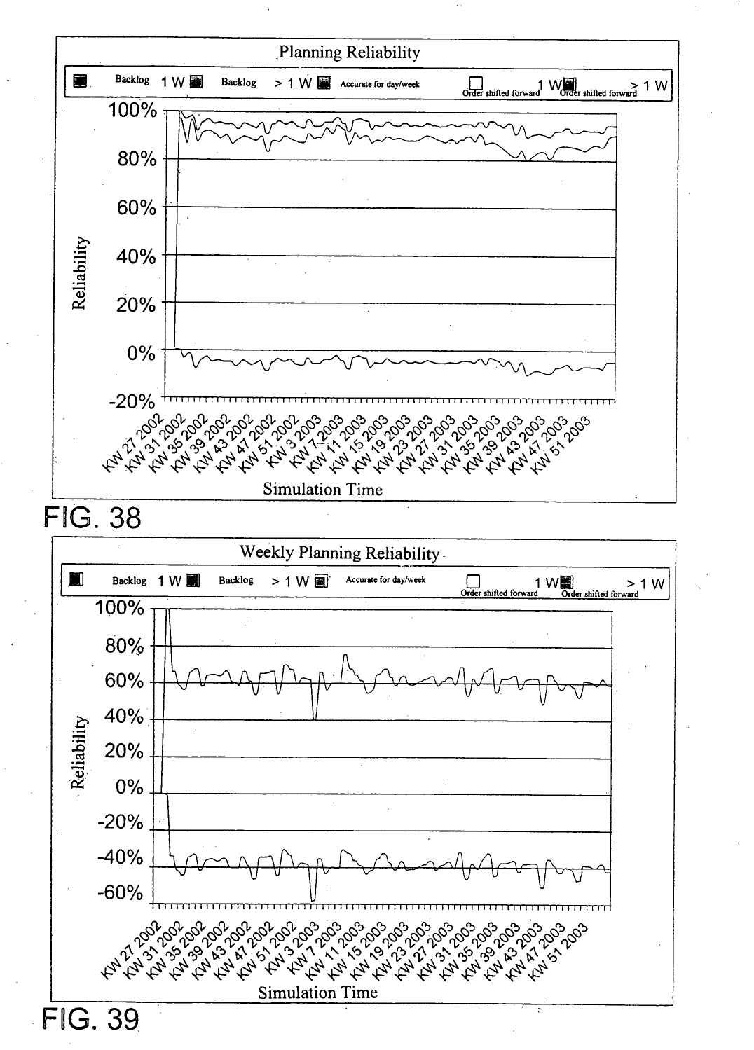

FIG. 38 planning reliability;

FIG. 39 weekly program reliability;

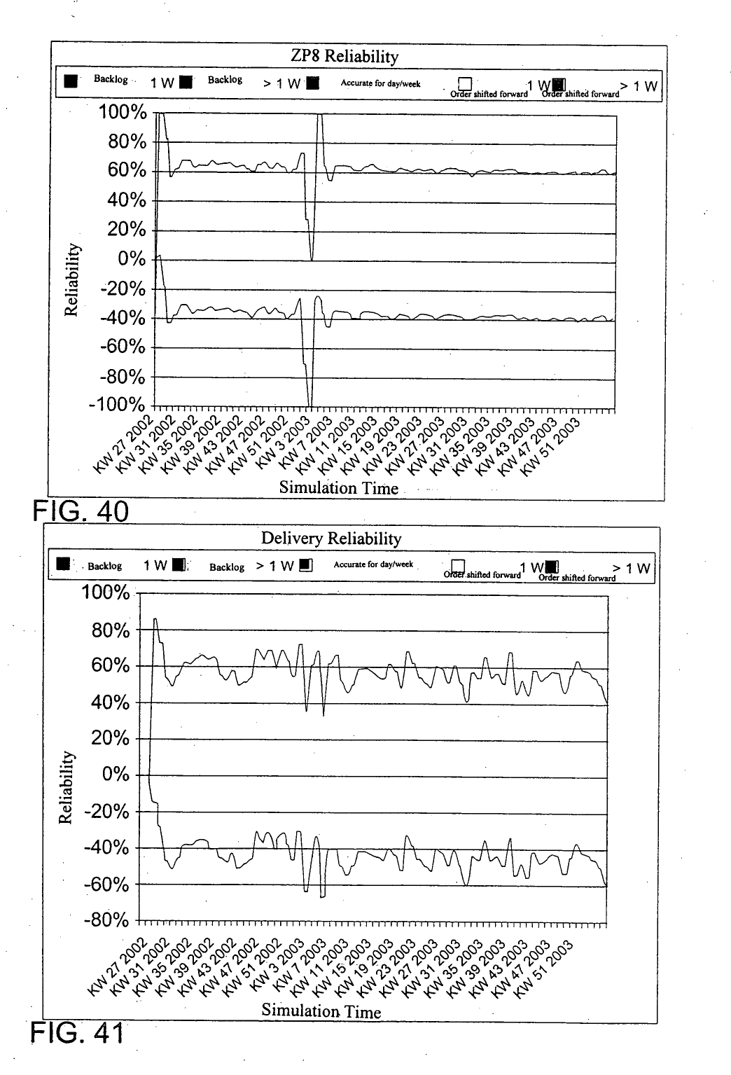

FIG. 40 ZP8 reliability;

FIG. 41 delivery reliability;

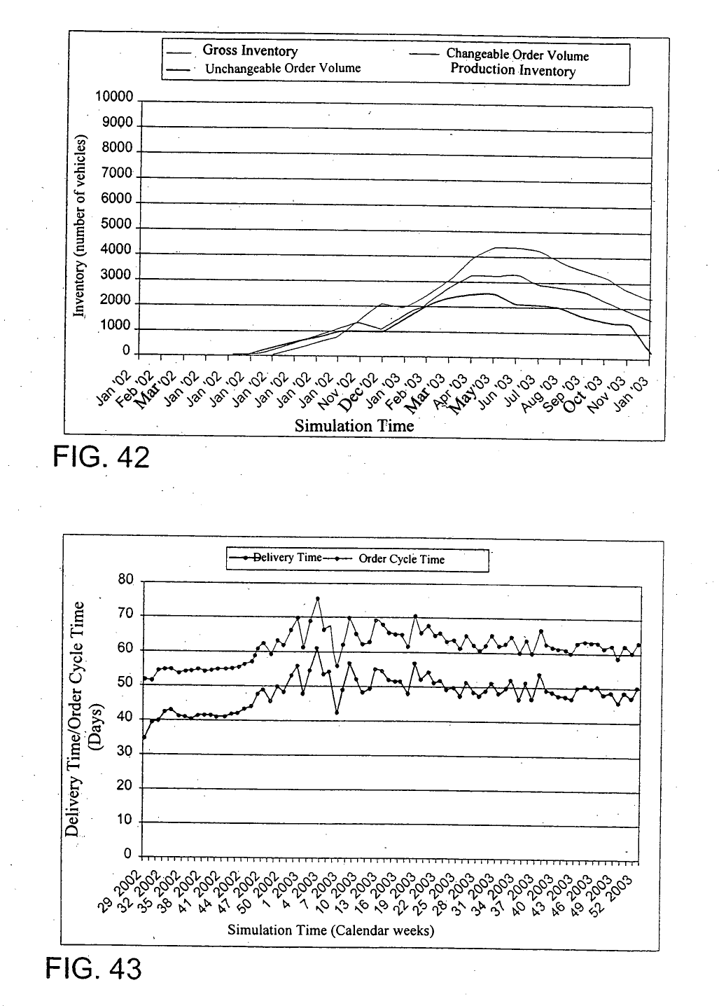

FIG. 42 inventory;

FIGS. 43 to 49 results of the simulation with an exemplary basic model and the additional assumption of a strike, without taking counteractive measures:

FIG. 43 average delivery cycle and order cycle time;

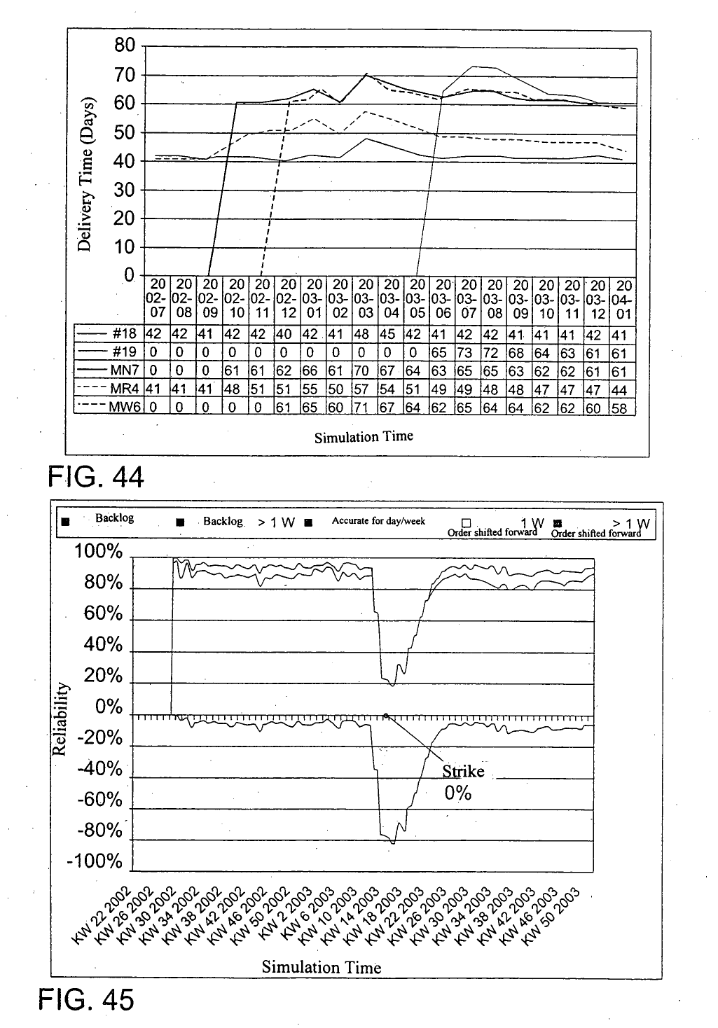

FIG. 44 delivery time for vehicles with a certain engine;

FIG. 45 planning reliability;

FIG. 47 weekly program reliability;

FIG. 47 ZP8 reliability;

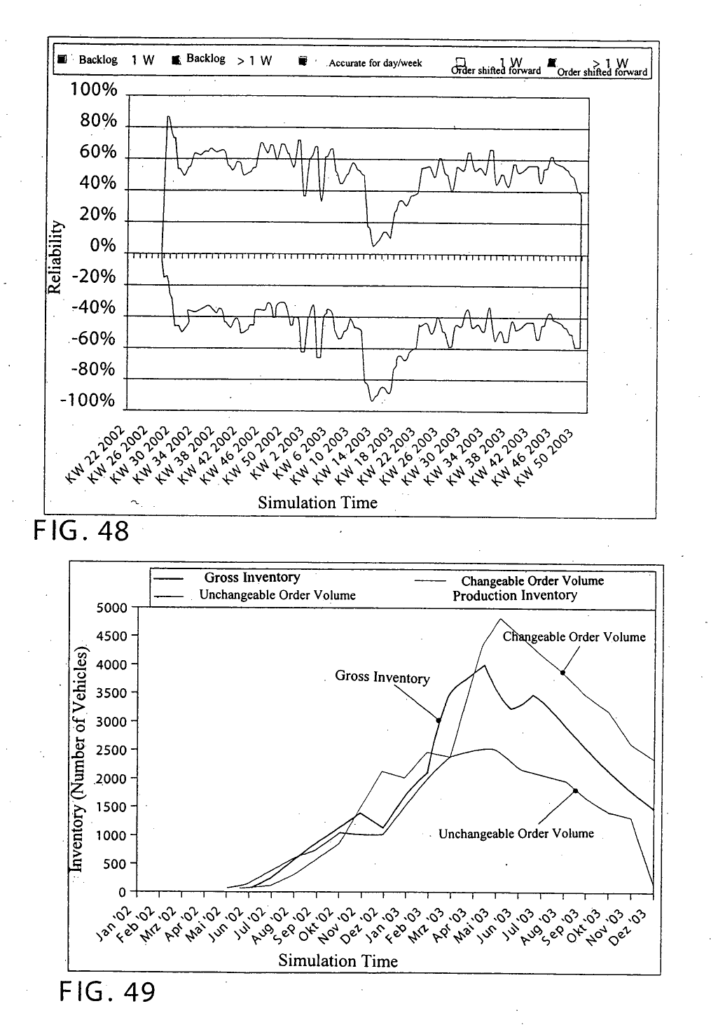

FIG. 48 delivery reliability;

FIG. 49 inventory;

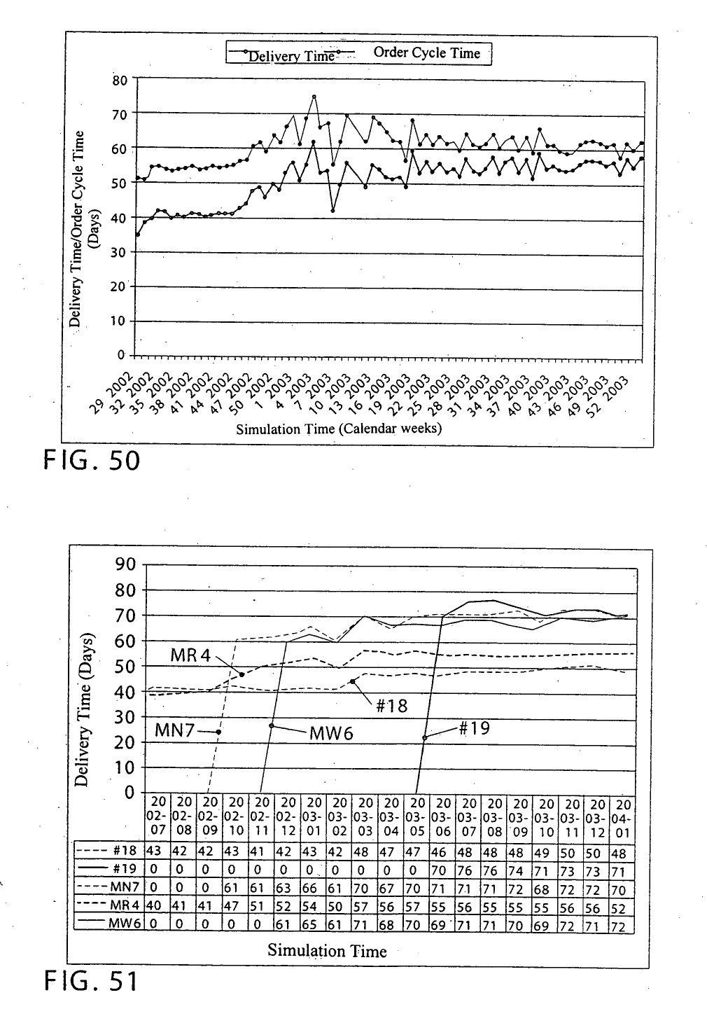

FIGS. 50 to 56 results of the simulation with an exemplary basic model and the additional assumption of a strike, and reduction in the nominal vehicle production as a counteractive measure:

FIG. 50 average delivery cycle and order cycle time;

FIG. 51 delivery time for vehicles with a certain engine;

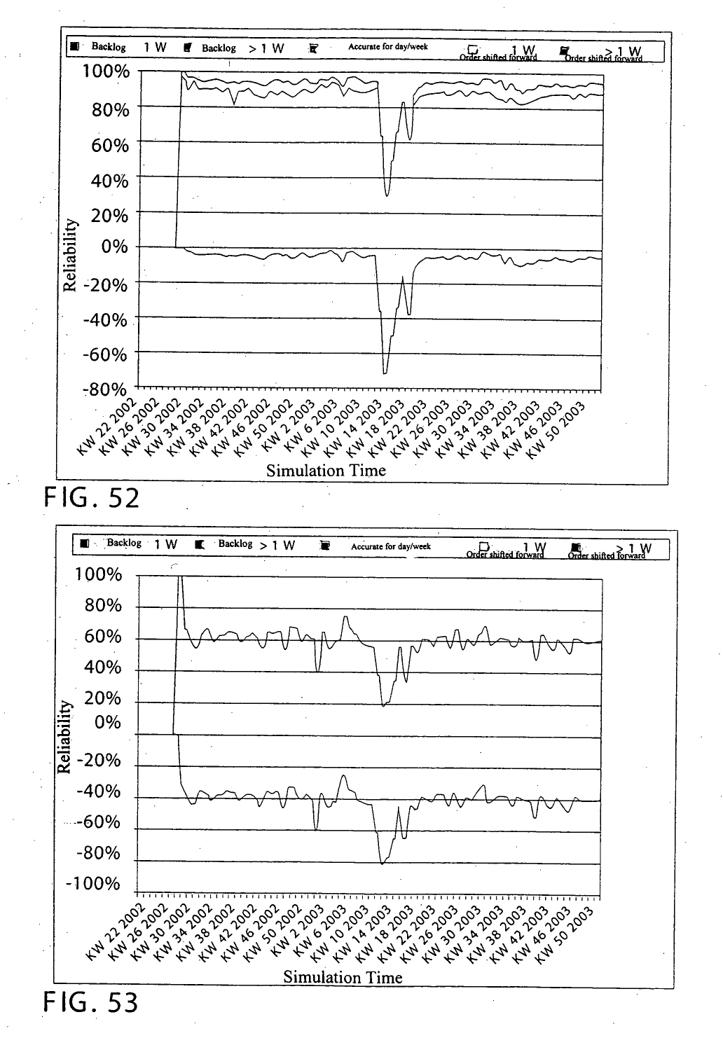

FIG. 52 planning reliability;

FIG. 53 weekly program reliability;

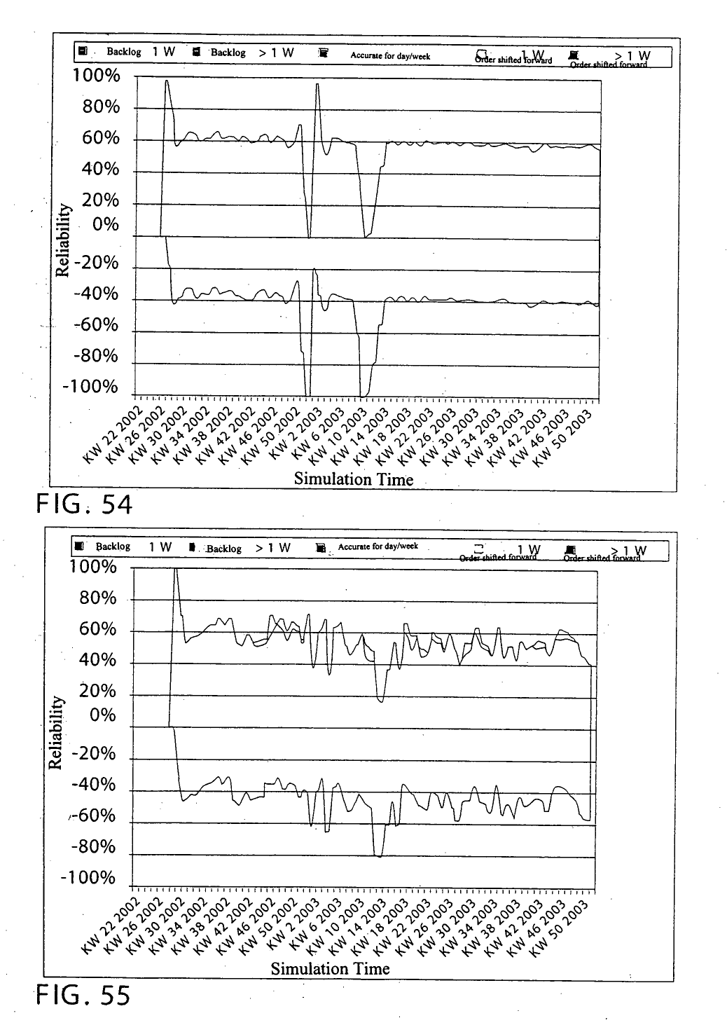

FIG. 54 ZP8 reliability;

FIG. 55 delivery reliability;

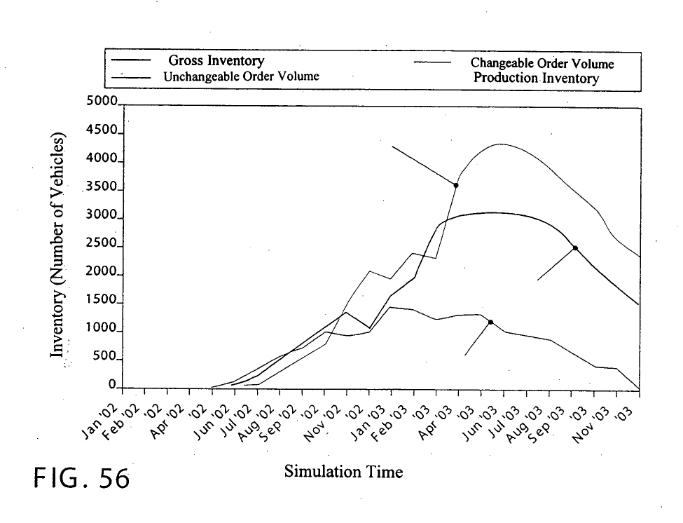

FIG. 56 inventory.

In the following, exemplary embodiments of the invention will be described which include various levels of detail of order processing in the automotive industry.

The customers require a lot from the vehicles and from the service package, which the automobile manufacturer ties to the products. The service which does not just begin with the first after-sales service, but rather on the purchase date of the vehicle, plays a decisive role in the buying pattern of the customer, in addition to high product quality, optimum operating efficiency and product reliability.

To optimize the service before a new vehicle is delivered to the customer, the automotive industry strives, on one hand, to shorten as much as possible the delivery times, which is defined as the time between the customer order and delivery of the vehicle, and on the other hand, to maximize the delivery reliability.

It has been noticed that this goal can typically only be achieved by redesigning the business side of order processing process, starting by setting a yearly sales forecast and with related program planning, by soliciting orders from customer, ending with the delivery of the vehicle to the customer.

The task associated with the design of the order processing process is related to the complexity of the system where the process is executed, and the many ways by which the system behavior can be influenced intentionally, for example through changes in the control principles, or unintentionally through breakdowns.

For evaluating and optimizing the dynamic behavior of the system and the quality of the business side of the order processing process before the implementation, but also in later operating phases, an instrument must be available as an experimental setting which enables quantified statements about the system behavior under varying system loads and alternative control principles.

The quality of the order processing process can be evaluated primarily based on the following success parameters:
reducing the delivery times,
ensuring the delivery reliability,
optimizing the capacity utilization,
minimizing the vehicle inventory in the distribution system.

Flexibility ranges must be integrated in the order processing process, which allow a quick adaptation to changing boundary conditions. Knowledge of these ranges and the associated reaction range is an important prerequisite for being able to merge the illustrated success parameters into a global optimum. In reality, quantified statements are required for:
the capacity limits of the various systems and subsystems (dealer network, sales, production, distribution),
potential bottlenecks in the capacities,
the effect of different control principles under varying boundary conditions,
the interdependence between inventory of materials, inventory of new vehicles, cycle times, delivery dates, delivery reliability, and capacity utilization,
the existing restrictions and their effect on the order processing process as well as knowledge about possibilities for eliminating restrictions in the short-term or long-term.

For assessing and evaluating the dynamic behavior of the system “vehicle production” under a newly defined workflow management, which is described by the order processing process, one or more simulations of the order processing process are performed with the method of the invention.

To subsequently attain specific targets, a modular simulation model was constructed which allows an evaluation of the system behavior under different boundary conditions. The model is also used to illustrate optimization potentials for continuous improvement of the business side of the order processing process in the planning as well as implementation state. In addition to modeling the process, the simulation studies can also be used to recognize and evaluate weak spots (for example bottleneck in the capacities) of the system. The benefit of, for example, an increase in the capacity at a certain facility can be quantified in terms of success factors, so that possible investment decisions can be supported.

In addition to the dealer network of the Federal Republic of Germany, the exemplary simulation model models in an abstract form the central distribution and planning regions, selected production sites and the distribution of the manufacturers. In addition, the core processes of suppliers, important order modules as well as the interfaces to the production departments of the automobile manufacturing plants are crudely displayed.

The exemplary simulation instrument accomplishes, among others, the following goals:

Integration into the order processing process of all manufacturers (concern) and production locations in the network:
The order processing process must here be developed as an open conceptual framework for adapting the process to market-, location-, and customer-specific requirements. In a simulation model, the required changes must be implemented and their effect on the dynamic behavior must be evaluated.
The simulation model is therefore, on one hand, a modeling environment for the adaptation of the open reference model and, on the other hand, a model repository for the model components already configured for certain location and brands.

Evaluation of quantity deviations in the long-term to short-term planning:
The cycle time, the inventory and the delivery reliability depend substantially on a match between capacity availability and capacity demand. This match must already be performed in the planning stage of the yearly production based on sales forecasts, to adapt the company to seasonal variations (so-called breathing company). Long-term capacity planning must in particular being matched to personnel planning, so that annular working time models to be taken into consideration.
The exemplary simulation can be used to evaluate different annular working time models, but also different shift models, with respect to their effect on the breathing company. Flexibility ranges can be evaluated, which are related to alternative methods for planning labor utilization.
In addition to long-term capacity adaptation, the exemplary simulation model can also be used to test different methods for mid-term and short-term capacity adjustment, in order to ascertain, how the system components (production, distribution, etc.) react to the various changes in capacity demand, and which short-term control interventions can be implemented and with which result (effect on cycle times, delivery reliability, etc.).
The short-term changes in capacity demand are caused by volume-related (number of vehicles) and equipment-related changes in the orders (equipment modifications).
To optimally match long-term, short-term quantity and capacity planning, planning functions are integrated in the concept of the exemplary simulation instrument, which require an interaction between the dealers and the manufacturer. These planning functions include generating a yearly sales forecast, matching a sales target with the available capacities, soliciting firm orders from the dealers as well as executing assumptions (conversion of firm orders into individual orders which completely specify the vehicles), and permanently matching the assumptions with the customer orders or dealer specifications for vehicles without an actual customer order until shortly before assembly begins.
The dealers can then advantageously match existing assumptions with customer orders up to three days before M0 and thus satisfy customer preferences on short notice.
This concept increases planning reliability (guaranteed production quantity through firm orders three months before M0), shorter delivery times and in increased delivery reliability for the manufacturer, thereby enhancing the competitive advantage of the various brands.

Analysis and systematization of the restrictions of the order processing process:
Different restrictions can be postulated for optimizing the business process. These can include company strategies (quotas for diesel, etc.), labor agreements, supplier capacities, production site restrictions, etc. The simulation instrument can be to assess the effect of these restrictions on the success factors of the order processing process to help decide the advantages associated with the elimination of various restrictions.

Analysis of performance limits and evaluation of measures for moving boundaries:
The performance limits of individual systems are determined by the technical capacities and availability of personnel. Experiments in the exemplary simulation model with different system loads can elucidate potential bottlenecks in the capacity under various boundary conditions (for example, severe deviations of the order performance from the forecast).
In particular, the simulation studies can show potential advantages of a flexible distribution of the production program to different production sites for various models and types, as they relate to capacity utilization, delivery times as well as other success factors.

Evaluation and optimization of the supplier interface in the order processing process:
Integration of the suppliers in the order processing process plays an important role to prevent shortfalls which necessarily extend delivery times and place the delivery reliability at risk. The simulation model can be used to check, which information must be provided to the suppliers at what times to ensure delivery of important order modules (heavy items) commensurate with demand.
The simulation tool can be used to evaluate the advantages of information obtained by the suppliers from the sales forecasts, the contents of the firm orders as well as changes in the assumptions, so as to optimize the respective production and distribution processes.

Evaluation of alternative distribution strategies:
The simulation can also be used to check to which extent the distribution target can be considered to plan the production sequence and which advantages or disadvantages are associated therewith.

The simulation simulates the dynamic order processing process in form of a model to gather information that can be applied to the real world. In general, simulation represents a tool for dealing with reality.

Simulation therefore helps to generate a model for modeling the dynamic behavior of real systems. A system is defined as the entirety of elements, including relationships between the elements and their features. The features describing the system are the system's state parameters. Changes in the state parameters reflect changes of the system environment. The evaluated systems can be facilities, such as factories, but also processes. In reality, the intent is to investigate the system behavior in a changing environment. Simulation is particularly useful for modeling complex real-world processes which are difficult to model. The goal is to gain understanding and mastery of this complexity. A simulation can more quickly and more easily eliminate uncertainties about the behavior of dynamic systems in different environments.

The complexity of real dynamic systems makes it difficult to understand operational relationships between the various factors that affect the systems. By generating a model within the framework of a simulation study, the complexity can be reduced through a comparative statistical analysis, i.e., only a single parameter is varied when comparing alternative process configurations. The effect of the impact parameters on the evaluated item is measured. Advantageously, with the intrinsic functionality of simulation instrument, the effect of single events can be determined and evaluated in isolation. Moreover, the process can be improved by varying factors that operate on the system in parallel.

In a modeling and simulation process, for example in the order processing process of an automobile manufacturer, key characteristic parameters for assessing the process, for example delivery time and delivery reliability, can be investigated. In this way, optimization potentials and decision alternatives can be discussed.

Simulation is used in different areas of the workplace as a tool to model dynamic systems. Simulation can aid in the investigation of economical, sociological and ecological problems.

Use of simulators is concentrated in the following areas:
in science to investigate system behavior,
in technical areas for developing systems,
in system management,
in development planning.

Order processing in automobile manufacturing represents a particular application for simulation. Simulation is particularly used when
uncharted territory is explored,
the limits of analytical methods have been reached,
complex operative interactions overtax the human imagination,
experimentation on real systems is not possible or too expensive,
the temporal workflow of a facility is to be investigated.

A simulation tool is used in the investigation of order processing processes, or in general for production and logistics, to achieve the following specific goals:
improving the quality and reliability in planning,
generating an understanding of the system and mastering the system complexity.

From the business perspective, simulation is of great importance as a tool for decision making in complex processes. Decision alternatives can be simulated before implementation. Results of the simulation allow conclusions about the consequences of certain decisions on the entire system. Potential decision errors can therefore be prevented from the start.

In summary, simulation tools are typically used where reliable statements about the behavior of complex dynamic systems have to be made with a comparatively low investment.

Advantageously, simulation tools can therefore be employed in the following areas:

Understanding the system
sensitivity of parameters,
supportability and testability of the selected solution,
avoidance and elimination of bottlenecks,
dynamic analysis and visualization of the entire process flow.

Cost-effective solution
optimization of process flows,
eliminating or simplifying system elements,
optimizing buffer sizes and inventories.

Safety gain
confirmation of planning tasks,
minimizing business risks,
functionality of the planned system,
functionality of the control.

So-called reference models were used for the exemplary simulation. These reference models include, for example, ready-made components. Examples for components are machines, transport means or inventory. This significantly reduces the complexity for conducting the actual simulation experiments.

The provided components can be specifically combined for the respective task. The modeling complexity for the user is then limited to parametrizing the functionalities of the employed components. This approach can significantly accelerate model design.

In particular, very complex situations require an abstract view of reality when creating a model. The real system can in most cases not reproduced in detail. It must be checked in this context, what the model can say about the reality, based on the selected degree of abstraction, which ultimately factors in the evaluation of the simulation results and therefore decides the general advantage of the simulation method.

Defining the degree of abstraction in the model creation is part of the simulation study which will be briefly described below.

FIG. 1 shows schematically the process flow for performing a simulation study.

Unlike diagrams of simplified process flows, the diagram shown in FIG. 1 takes into account the problem that a model may have to be changed after successful verification and validation.

The various elements of a simulation study will now be briefly described.

It must first be decided which question the simulation is going to address. This aspect is of particular importance for setting the boundary of those areas that are relevant and those areas that are irrelevant for answering the problem of the real system to be modeled. Depending on the question, it has to be determined which parameters of the system must be considered in the model. After these questions have been answered, it can be determined which details must be addressed when creating the model so that the question can be answered in a meaningful way. The complexity of the model will depend on the level of abstraction.

To model the problem defined in the first step in form of a model, the relevant input variables have to be systematically defined. It must also be determined which parameters have a significant influence on the system. The relevant significant parameters then must be classified. The dynamic parameters are of particular interest in the system analysis. A sensitivity analysis often helps to determine the degree to which a single parameter affects the system.

Dependencies between the input in the output variables are to be taken into account as characteristics of the system behavior when creating a model. The necessary input data are acquired in parallel with the development of the model.

After developing the formal model, the contents of the conceptual model has to be transferred to the computer program. During the development of the conceptual model, the system components to be modeled in the model are extracted. These are to be transferred to the model in a suitable and detailed manner. Conventional standard simulation tools can be used for the implementation with many problems that have a simple structure. As mentioned above, many of these standardized simulation tools are based on the so-called building block concept. Although such tools can be relatively flexibly applied in certain areas, they have little utility with complex problems, such as for example order processing in the automotive industry. New software also had to be developed even for the exemplary simulation tool.

The model must be verified and validated after implementation. Verification refers to a check of the individual steps of the modeling process. Stated differently, it is checked if the model relationships formally defined during the conception of the model are actually implemented in the computer model.

Conversely, validation of the model addresses the question, if reality, as far as the purpose of the simulation is concerned, is appropriately and correctly modeled in the model. Validation is simple in situations where a real existing system is to be modeled. The state of the real system must first be modeled in a model. The model is suitable if the results of the simulation agree with those of the real system for similar parameter settings. The model must model the behavior of the real system with sufficient accuracy and without error.

Stated more simply, verification checks if the correct items are modeled in the model, whereas validation checks if the items are correctly modeled.

If subsequent to the verification and/or the validation the accuracy of the model is cast into doubt, then the simulation study must be interrupted at this stage and the results are fed back to the model development. FIG. 2 illustrates the relationship between model verification and model validation.

After the quality check has been successfully concluded, the experimental phase can begin.

Several aspects have to be considered when evaluating the results of the simulation flows. The following statistical rules have to be observed:
if dynamic processes are simulated, then the modeled system requires a certain “settling” time until the model reaches a stable state (during this phase, the values from the so-called “warming up” period are excluded from the overall evaluation).
the independence of the simulation flows is characteristic for simulation experiments with stochastic distribution functions.

To increase the accuracy of simulation flows with stochastic distribution functions, the simulation experiments are replicated n times with the same parameter setting and an average value over n is determined.

Another method involves presetting a confidence interval, which limits the range that includes with a certain probability the real value to be determined.

After the simulations are performed, the results must be interpreted. The user can gain insight into the behavior of the real system based on the simulation experiments. The interpretation, however, should always be performed by keeping the applied abstraction in mind.

Simulation experiments performed in a company are typically used as decision tools for management decisions. In particular, the results of operatively applied simulation tools affect real decisions. In this context, the quality of the results is an important prerequisite for acceptance by the user.

Modeling will now be described in detail with reference to a specific example directed to the simulation of an order processing process for the production of motor vehicles.

The order processing process includes all sub-processes from the customer order to delivery of the vehicle to the customer. In particular, the following steps can be specified as sub-processes of the order processing process:

| | |
|---|---|
| Order acceptance: | the dealer and customer agree on a vehicle type, |
| | equipment and delivery date. If the customer orders |
| | the vehicle to the agreed-upon conditions, then the |
| | order is forwarded to the distribution channel of |
| | the manufacturer. |
| Program planning: | customer and dealer orders are planned by taking |
| | existing restrictions into consideration. |
| Production: | after an order has been associated with a production |
| | site and is planned in a weekly or daily program, the |
| | vehicles are produced according to the production |
| | program. |
| Distribution: | after the vehicle is completed and accepted at the |
| | production site, the vehicle is shipped and trans- |
| | ported to an intermediate storage facility or directly |
| | to the corresponding dealer. The vehicle is sub- |
| | sequently delivered to the dealer. |

Before that, the market demand is forecast. The production quantities are planned based on this forecast after checking the available capacities. The planning applies to the vehicles as well as to their equipment. Based on the planned quantities, the parts demand can be determined. The planned quantities also define the range for planning orders. One goal for optimizing order processing is to significantly reduce the delivery times, which can be accomplished with the invention.

One solution for optimizing order processing is the implementation of a new process structure. For example, in a new process structure, a sequential process architecture can be substituted with a simultaneous process architecture. The different links of the process chain—forecast, program planning, production, and distribution—are systematically interrelated.

A core point of these attempts is the introduction of a process where a vehicle which is still in the order allocation stage, is allocated to a real customer as late as possible.

FIG. 3 compares the two process structures.

For example, the delivery times may be reduced by converting vehicle planning in the factories from a ZP8 week to a ZP8 day (ZP8=counting point 8; the counting point 8 indicates the completion of a vehicle). Unlike present processes which plan production according to a calendar week, daily production goals always transfer only the daily order volume to production. This process is referred to as “Day Reference”. Unlike conventional order processing, the “Day Reference” process allows a time shift in the freeze point (EZP) for the order. The freeze point marks the latest possible date when changes to a equipment or an order are still possible. It is a basic idea of each process step indicated in FIG. 4 to increase the flexibility in order processing.

The specification of an order can be changed until shortly before production starts, depending on the features or equipment to be changed.

Introduction of the “Day Reference” process depends on several requirements. For example, the release of alternative dates must be stable. Moreover, the lead times for procuring parts must not be outside the time window when the specification of an order can still be changed. Otherwise, only small quantities of equipment can be subject to changes. Otherwise, the advantages resulting from the flexibility of the order processing could not be fully utilized. The delivery times could not be significantly shortened.

With the “Day Reference” instead of to the “2+2” process described below, an order can still be fixed in the order allocation process to a ZP8 day, if orders remain unchanged. However, unlike in the “2+2” process, orders can then no longer be varied in the production.

This measure produces a constant progression of orders before production. The Day Reference therefore stabilizes and simplifies the process. A consequent changeover to the modified process structure may cause unforeseen complications. Therefore, diverse process steps have been developed that enable a smooth transition. These process steps are illustrated in FIG. 4.

The delivery time is also gradually reduced by introducing the respective process step stepwise and evolutionary.

Because problems may occur during implementation of the process step “Day Reference”, as mentioned above, a pre-stage “2+2” it is inserted in the exemplary process. Under certain conditions, this process already enables a processing time of 14 calendar days. “2+2” is meant to indicate that with an order time from the dealer of four weeks (=2+2), the order can be changed no later than approximately two weeks before the ZP8 date. This is unlike “1+3”, where also four weeks (=1+3) are available between order and production date. However, the order is already frozen three weeks before the ZP8 date, so that the order can be changed no later than three weeks before the ZP8 date.

The cycle time is hereby reduced by one week compared to “1+3”. With “2+2”, the dealer orders a vehicle no later than four weeks before the planned production date (ZP8 date). Changes in the order are possible up to about two weeks before the ZP8 date. The date does not shift when an order is changed. The dealer can enter an order in the systems even without a firm customer order. The specification of the equipment in an order from a dealer can then be changed according to the customer selection up to the freeze time.

It will be appreciated that the order processing process in the automotive industry is a very complex system with numerous dependent system components and cross connections, so that it appears to be difficult to control the functionality of the individual links of the process chain when looking at the totality of the real system. For this reason, the simulation tool described below in detail will be used. The order processing process is hereby transferred to a model and simulated.

It is the intent to optimize the total process for determining the effects of changes in the parameter settings on all subsections of the process chain. Initially, an idealized system state is modeled in the exemplary simulation. The result of the simulation of this reference model forms a benchmark for subsequent simulations, whereby the system state is only varied with respect to real observed events that can be impair the continuity of the process flow. In addition, so-called “worst case” scenarios can be tested, which determine the constellation of system parameter settings which cause the system to become unstable, i.e., the functionality of the system is at risk.

This form of system analysis is not practical with real systems, because this approach would be very expensive.

A complete order processing model is subdivided into the subregions: vehicle design, sales, planning, markets/distribution and production sites. FIG. 5 shows an overview of the complete structure of a simulation model and the logical links of the system components. The aforementioned components of the model structure—vehicle type, sales, process control, markets/distribution, production sites—and their components will be briefly described hereinafter in general and then in more detail for two additional exemplary embodiments. In parallel, is illustrated with respect to the first case how the rules of the real system are implemented in the model design. The approach for building the model will then be described with reference to an actual exemplary simulation study.

Sales

The heading “Sales” refers to the functional dependence of the global, absolute sales value of the considered vehicle class in the simulated timeframe. Depending on the formulation of the problem, seasonal variations in the sales volume can be defined, for example by entering the sales numbers on a monthly basis instead of an aggregated yearly basis. This functionality is also important, for example, in relation to the identifier “Breathing Manufacturing Plant”.

### Vehicle Type

For example, a vehicle is completely described by a model key with six digits. Components of this key are information about, for example, vehicle class (platform and series), identification of the body (limousine, station wagon and the like), equipment (basic, trend line, comfort line, highline, and the like), as well as identification of engine and transmission.

Hierarchically subordinate to the model key, the vehicle type is broken down into a list of so-called “PR numbers.” The PR numbers uniquely describe a feature or piece of equipment. Each feature is associated with exactly one PR number. The PR numbers are combined into “PR number families.” For example, the PR numbers “without airbag” and “airbag for driver” are associated with the PR number family “airbag (short identifier AIB)”. Each vehicle is uniquely described by exactly one PR number from each PR number family. This structure is also taken into consideration in the design of the model.

Country-specific and market-specific attributes in the vehicle type are defined separately. Examples are vehicles with right-hand steering or particular emission requirements.

The vehicle design takes into consideration in different levels. The structure is illustrated in FIG. 6. In this example, the levels company (root, 1^{st} level), platform (2^{nd} level), vehicle type or vehicle class (3^{rd} level), body type (4^{th} level), equipment (5^{th} level) and country identification (6^{th} level) are taken into consideration. The number of levels depends on the model selection. For example, if only the single platform or only a single vehicle class of the platform is considered, then the corresponding planes can be suitably combined. Conversely, the level of detail can be increased by modeling additional levels. In the context of creating the model, it must be defined from the beginning how far the model can be abstracted from the real structure of the vehicle levels.

Moreover, installation rates (EBR) have to be defined on all levels. The installation rates of a feature defines the contribution of this feature in relation to the family of features. If only a single vehicle type is modeled in each level, then the EBR of each level is 100%. Additional attributes of each level are “PR numbers assumptions,” “PR numbers specification,” and “PR numbers groups.”

The “PR numbers assumptions” are to be understood as those features which are already installed in the basic configuration of the respective vehicle type, whereby one corresponding feature of a PR number family is to be modeled as an assumption. The “PR numbers group” is defined as a combination of features. This functionality can be used to model requirements and exclusions. Combinations of features may be required for technical reasons. On the other hand, this functionality can also be used to model distribution measures. For this reason, the customer can select in a limited number of cases only from a number of so-called equipment packages, which reduces the number of choices and makes it easier to predict features.

The “PR number specifications” on the other hand include all the features of each feature family, from which the customer can individually configure his vehicle. Installation rates must be defined for the “PR numbers groups” and for the “PR numbers specifications.” Providing an EBR is not required for the assumed features. The EBR of the respective assumed feature can be computed as the difference between the sum of the EBR of the unassumed features of a PR number family and one.

Process Control

The time horizon for the forecast and planning of the vehicles is defined in the context of process control. The different process steps, as described above with respect to conversion to a modified process structure, can be parameterized based on target date series. Target date series image the rolling planning cycles. The times and corresponding time intervals between events during the planning process have to be defined.

Markets/distribution

In the markets, a distinction can be made between dealers (domestic market) and importers. This differentiation can be meaningful because, unlike in the domestic market, the vehicle orders from export markets are not based on customer orders, but typically on forecasts. The vehicles in this case are specified by the importer. A dealer/importer is completely identified by an identifier, the location of the railroad station at the destination, the distribution channels, the preferred factories, and specific dealer planning parameters. The distribution channels can be subdivided, if necessary, into so-called sub-distribution channels. This functionality makes it possible to nest the distribution paths. For example, alternative transport means and different routes cab be optionally modeled. In the aforedescribed embodiment, each distribution channel is defined by the attributes “point of origin,” “destination,” “schedule” (=time between two transports), “transport capacity,” “transport duration” and “loading duration.”

Information relating to the dates for volume agreements and vehicle orders of a dealer/importer are part of the specific dealer planning parameters. Additional characteristic is a classification of the customer by segmentation. In the exemplary model, the customers are differentiated according to their preferences with respect to delivery time.

Production Sites

A production site is completely described by the identifier, the capacity, the cycle time, down time, destination station, and the vehicle classes assembled at the production site. Down time indicates the planned capacity of one or several features is temporarily curtailed. The capacity of a production sites is determined by multiplying the number of units produced per hour and the weekly operating time of the production site. Official holidays and vacation time are listed separately in the exemplary simulation tool and considered for planning the capacity. A degree of flexibility in the time response can be defined for the throughput as well as for the weekly hours of work.

In the illustrated exemplary embodiment, the values for the planned cycle time and the distribution of the cycle times should be provided as a function of the actual cycle time. The production date of an order is planned based on the planned cycle time. The ZP8 reliability is affected by the variance of the cycle time distribution. The ZP8 reliability can be improved, for example, by decreasing stochastic effects.

Based on these results, statements about the stability of the order processing process as a whole can be made. If only the stochastic manufacturing processes are responsible for the instability in the order processing, the delivering date can be determined exactly based on deterministic production times under otherwise identical conditions.

Disabling of features in the exemplary embodiment are also announced to the production sites. Disabled features are described by their definition, such as information about an advance warning time, their duration and start as well and the fraction of the capacity affected by the disabled features. A change in the implementation date could also be modeled as part of the functionality “Disabled Features.” The term change in the implementation date is used when a feature cannot be implemented on the original date (the term “start of production” (SOP) is also used synonymously with “implementation date”) due to a number of problems. This situation causes particular problems in cases where non-adherence to the planned implementation date is known only late in the process and can no longer be taken into consideration in the planning stage. If an implementation date is changed, then the disabled feature is substituted by a feature from the same PR number family. A sufficiently long advance notification should be provided due to the complexity and the existence of several requirements and exclusions of combinations of features. It becomes evident which effect a late announcement of a change in the implementation date has on the stability of the process and thus on meeting the planned ZP8 date.

Information about the actually built vehicle types and the corresponding relative portions of the vehicle types for the entire production of the respective vehicle types are relevant only if more than one production site is included in the model and vehicle types are not exclusively manufactured in one factory. Otherwise, the fraction is always 100%.

Many problems can be investigated with the exemplary embodiment of the simulation of the order processing process. The effects of both strategic and tactical-operational decision alternatives can be simulated. The following examples are intended to give an overview of the universal applicability of the invention. In all cases, variations in the described characteristic features delivery time, delivery reliability, capacity utilization and inventory are analyzed, if certain factors have a negative impact on the continuity of the process.

Effects of strategic decisions can be investigated with respect to
implementation of a new process step,
reduction in complexity (modularization in sourcing and distribution),
alternative sourcing strategies (for example: modular sourcing),
alternative production concepts (production based on customer orders vs. production for inventory),
site planning,
alternative distribution channels,
long-term capacity planning (technical capacity),
new dealer network structures.

The simulation tool of the invention can be used to investigate the effects of tactical operating measures due to:
shift in implementation dates,
bottlenecks at suppliers,
not predicted demand for vehicles, equipment,
temporary capacity restrictions in the factories due to a machine failure and the like.

In the following, the overall flow of the simulation study will be described with reference to the model “vehicle delivery at a delivery location of the manufacturer(s)”.

Unlike conventional delivery of new vehicles at a dealer, the customer is offered in the examined model the option to receive the new vehicle at a delivery point of the manufacturer(s). The vehicle is still ordered from dealers on location.

Delivering the vehicle at a delivery point of the manufacturer(s) is difficult because vehicles to be handed over to the customer at a certain time must also be available exactly at that time. This requires a delivery reliability of 100% and requires a binding planning process for the customized vehicles and stable process flows. In particular, the timing of the delivery to the customer according to the customer's preferences must be taken into account.

It can be demonstrated with the simulation tool according to the invention, how the aforedescribed logistic demand for delivery reliability can be realized. It is determined based on the status of the delivery, how the system must be adapted to indicate to the customer a binding delivery date no later than when the customer order is placed with the dealer. Presently, delivery of vehicles to the customers at the promised time is ensured by informing the customer about the earliest possible date for handing over the vehicle only after completion of the vehicle.

Because the customer cannot always receive the vehicle on short notice, the vehicles must be temporarily stored, which requires a certain number of parking spaces. This is expensive and ties up capital, and requires fixed cost for establishing storage facilities and variable cost for maintaining the inventory. These problems can also be addressed by looking at their monetary impact. It is therefore desirable to determine the savings potential, should the results obtained with the simulation tool of the invention be implemented in the real process design. The requirement for parking spaces are difficult to quantify exactly due to the many factors which can destabilize the process. The distribution of cycle time shows a large variance, if several effects operate on the system in parallel. It may then not possible to keep the delivery date promised to the customer.

It is a goal of the simulation tool to compare alternative process configurations. Accordingly, as described above, a model has to be generated which models the relevant features of the real system. Not all sub-processes of the order processing process are relevant for the specific circumstances investigated in these examples. Therefore, a suitable abstraction can be made.

For example, the problem can be investigated by modeling only be a single factory A. In addition, only the fraction of the vehicles manufactured in the factory A and destined for the domestic market has to be considered. In addition to limiting the process to the factory A and to the market in Germany, only the following levels of the vehicle design are represented in the exemplary model:
manufacturer,
platforms: AOO and A,
vehicle classes,
market/country identification (domestic/market Germany).

The range of the equipment included in the exemplary model is also limited to those equipment families which are typically regarded as critical. More importantly, the model should approximate the complexity of the real vehicle type. The complexity represented in the exemplary model relates to the equipment installed in the factory A for the German market with, for example, 13 exemplary equipment families. Accordingly, a total of 13 equipment families with, for example, 68 equipment features or PR numbers must be considered. The PR number specifications and PR number firm orders are also modeled in the exemplary modeling process.

The actual and desired installation rates of the equipment or vehicle classes are obtained from the respective planning systems. Because only the vehicle's steering system is considered in this example, the modeling of suppliers is irrelevant for answering this question. The scheduling timelines of the process step “2+2” used in factory A are also implemented in the model. The distribution of the production cycle time assumed in the model must correspond to the actual production time in the factory A. The visualization includes, for example, the net production cycle times. Machine downtimes (for example on weekends) are subtracted from the gross production cycle times. The assembly lines are modeled separately, because the production cycle times for the individual vehicle types have different distributions. No abstraction from the reality is performed.

For example, it will be assumed that the actual layout of the production sites for a first vehicle type X in factory A can be subdivided into three independent segments. The production cycle time of the respective segments are also assumed to be independent. This separation can be eliminated so as not to unnecessarily increase the complexity of the model. Instead, an average value taken over the production times could be used for the three segments.

A planned production cycle time of approximately 75 hours is assumed for producing the vehicle type X and of approximately 60 hours for a second vehicle type Y, whereby the planned production cycle time is composed of the sum for body shell work, painting and assembly.

In the exemplary simulation, only logistics or technical effects in the production should be evaluated in the process analysis. FIG. 7 shows an overview of the input and output data required for this model.

Implementation of the Model

General Implementation of the Conceptual Model

The conceptual model is initially implemented in the simulation model as a reference model. A time period of two years was defined as simulation time interval with a vehicle volume of approximately 500,000 vehicles. The distribution of the production cycle time is modeled in the model via a histogram, meaning that certain cycle time intervals are determined and the percentage of vehicles with a production cycle time within these time interval values is determined.

FIG. 8 shows the actual cycle time distributions for the assembly of the two vehicle types X and Y in factory A.

FIGS. 9 and 10 show the cumulative cycle time distributions for the two vehicle types X and Y.

In the following, two different process design configurations will be described for the simulation tool of the invention.

In the first embodiment, the reference model in scenario S1 is modified by considering the features associated with a vehicle delivery at a delivery point of the manufacturer(s). As already described above, an earliest firm delivery date is only set at the time a vehicle is completed (ZP8).

Between the completion of the vehicle and delivery of the vehicle to the customer at a delivery point of the manufacturer(s), the vehicle must be temporarily stored on specifically provided parking spaces. Based on experience, an average storage time of 14 to 16 calendar days is assumed. This target value, however, can vary. A time today element is modeled in the distribution channel for suitably representing the arrival time at the customer. The distribution defined in the model as customer arrival time indicates the time from the moment the customer is informed about the earliest possible delivery of the vehicle and the actual delivery time of the vehicle. The average customer arrival time is approximately 16 calendar days. A capacity of approximately 8700 parking spaces is provided at the factory site for temporarily storing the vehicles. In addition, satellite spaces with an undetermined capacity can be included.

In a first simulation step, the parking space requirement for the illustrated three configuration stages are is determined, assuming the actual distribution of the production cycle time of the two vehicle types X and Y is assumed (distribution Va in the FIGS. 11 and 12, respectively). The variance in the distribution of the production cycle time is then successively reduced (distribution Vb and Vc in FIGS. 11 and 12, respectively). These measures can increase the ZP8 reliability. This sensitivity analysis quantifies the impact of stochastic processes in the distribution of the production cycle time on the ZP8 reliability.

FIGS. 11 and 12 shows the distributions Va, Vb, and Vc of the production cycle time for producing the vehicle type X and the vehicle type Y, respectively. The decrease of stochastic effects in the diagram of the production cycle time distribution is easily visible in both cases. In the following, another embodiment of the simulation tool of the invention is described, wherein this configuration implements a second scenario S2.

The scenario S2 of the second embodiment is based on results from the sensitivity analysis regarding the decrease in the variance of the production cycle time. With a stable production process, the customer can be informed about the earliest possible delivery date at an earlier time. As a result, the average parking time of vehicle according to Zp8 is reduced. Optimally, the delivery date preferred by the customer can already be taken into account in the vehicle planning stage. Unlike the scenario S1, the range of the arrival time at the customer site is not implemented in the distribution, but already during the order planning stage as a desired delivery date distribution to the customer.

FIG. 13 compares the two scenarios. To facilitate the comparison between the two scenarios, the same distribution is used in scenario S2 for the desired customer delivery date as for the customer arrival date in scenario S1.

The model was verified and validated after implementation. As already described at the beginning, the model is compared with the conceptual model during verification, i.e., it is checked if all relevant system relationships defined within the scope of the concept are present in the model.

When the validity of the model is checked, the simulation results are compared with the data for the real system. This approach is recommended in all cases where real input data are used. In the exemplary simulation, both sub-processes and the overall process were checked. For validating the overall process, the actually measured reliability values from a reliability measurement for the factory A were employed.

Depending on the problem, it may be sufficient to base the evaluation on a single simulation run. This approach is justified, for example, in the context of the present problem, because the required parking space is only roughly estimated in a first step. Statistical methods must be applied to determine exact values, which may require executing several replications. The starting value used by the random number generator to generate the random numbers must be varied, because the results would otherwise just be repeated for each replication. It may be sufficient to determine the duration of the “warming-up” period by a rough estimate. This approach is typically acceptable, because only a maximum value must be determined for the concrete problem. Approximations should be employed, for example, if an average value for a certain initial value is to be determined.

As determined in evaluating the data of the exemplary simulation run, the modeled system needs three months to reach a steady state.

FIG. 14 shows the results for the required parking space based on the real distribution of the production cycle time (distribution Va) for the configuration stage 1 (delivery of 300 vehicles daily), configuration stage 2 (600 vehicles daily), and configuration stage 3 (1000 vehicles daily).

FIG. 15 shows processed results of the aforedescribed sensitivity analysis when taking into account the effect of stochastic production cycle times on the ZP8 reliability. The values listed in FIG. 15 for the standard deviation in the production cycle time were determined for a random sample of 1000 vehicle orders for each of the three assumed distributions. The expected value for the production cycle time agrees with the planned cycle time.

In a further approach, it may be useful to assume that a transition to the process of scenario S2 is only contemplated when the production process is stable. This prerequisite is at least minimally met by the production cycle time distribution Vc.

FIG. 16 shows the parking space requirement for the distribution Vc of the production cycle time. FIG. 17 shows in addition the saving potential for required parking spaces compared to the current process of scenario S1.

FIG. 18 shows the savings opportunities demonstrated in exemplary simulation results, which in this example can be exclusively attributed to a decrease in the fixed capital costs. The amount would be even greater if the costs associated with providing temporary storage areas the vehicles were also taken into consideration.

The calculation of the savings potential, if the parameters from scenario S1 having the production cycle time distribution Va were substituted by the parameters from scenario S2 having the production cycle time distribution Vc, is based on the following equations:
Yearly savings potential when changing the process=interest*average selling price*reduction in the average inventory

A commercial interest rate of 8% was assumed. An average selling price of 30,000 Euro for the vehicle classes considered in the simulation was assumed. The difference in the average inventory between the two scenarios was already determined in FIG. 17. It should also be noted that only vehicles produced in factory A are included in the calculation. These values would thus increase if the entire vehicle volume delivered to the customer is included in the overall calculation.

FIG. 19 lists the average saving for each vehicle in the respective configuration stage.

In a preferred embodiment, the simulation tool is divided into different program blocks which implement the aforedescribed steps required in the simulation for investigating the respective problem. These program blocks have the following functionality:

Program Block “System Load Generator”

The system load generator generates in a simple form the demand forecast of the dealers and the orders of the buyers. The forecasts are continually adapted (for example, monthly) to match the generated (actual) demands of the dealers.

The system load generator generates separately for each dealer and as a total at the begin of a sales year a simplified one-time forecast of the number of vehicles that could be sold over the next year. The major equipment features (“heavy items”) of the likely required vehicles are characterized in addition of the actual quantities.

The yearly forecast can have, for example, the form illustrated in FIG. 20:

It should be emphasized that this is a simplified forecast which only approximates the dealer forecasts.

The load generator generates for each dealer customer orders over the simulated yearly order flow, which have a similar simplified curve shape that deviates from the forecast for the year.

The forecasts for every week are updated for the following time period (for example three months) depending on the (average) curve for customer orders from the preceding months, resulting in an exemplary curve of the form shown in FIG. 21.

The output data of the system load generator include the yearly dealer forecasts, the customer demand, as well as the updated weekly demands (quantity and “heavy items” of the required vehicles) of the dealers for the next forecast timeframe. The output data represent in simplified form the input load for the subsequent program blocks and can also be visually displayed.

Program Block “Capacity Adjustment”

The weekly requirements of the dealers are adjusted and matched in this program block with the modeled abstract capacities of the factories and the likewise approximately modeled capacities of the suppliers (see below).

The requirements from the dealers are collected and accumulated. After the central distribution corrects the demand, which can be implemented in the model by, for example, demand and capacity limitations, the demand (quantities, items) are matched to the actual capacities of the factories and suppliers.

The process for matching the capacities is illustrated in FIG. 22.

Capacity matching produces approved firm order allocations for each planning week, which are then adapted to a predetermined module allocations and transmitted to the dealers (see FIG. 23).

The output of the program blocks “Capacity Matching” includes the approved firm orders and module allocations for the dealers. They represent the input for the program blocks “Firm Order Generator”.

Program Block “Firm Order Generator”

The “Firm Order Generator” produces for each dealer from the approved firm orders and module allocations concrete assumptions (firm orders and order modules) for a delivery week (see FIG. 24). Concretization of firm orders to assumptions depends on the customer orders received thus far by the dealer and on the demand forecast for the delivery week. This concretization is modeled by probability distributions with average values and variances.

Output of the Firm Order Generator are the assumptions for each dealer and delivery week. These individual assumptions are assigned to the factories by the following program block and converted into firm orders.

Program Block “Factory Assignment”

The input for the program block “Factory Assignment” are the assumptions of the dealers. These are matched to the restrictions (capacities, utilization, etc.) of the production facilities and suppliers. In this program block, the factories are assigned and the weekly assumptions are distributed over the delivery dates (see FIG. 25).

The output data of the program block “Factory Assignment” include concrete assumptions with identification of the production facility, the participating suppliers, and entry of the delivery day.

The concretized firm orders are transmitted to the dealers and form the input for the following program block.

Program Block “Assumption Manipulator”

The dealers receive customer demands during the entire process

Forecast→firm orders→assumptions→daily programs (see below)→production→distribution.

These are then compared in the reverse order of the process with the vehicle inventory that is available in distribution, production, the daily programs, the dealer assumptions, firm orders or predicted demand. If an unallocated vehicle is found in inventory which meets the customer preferences, then a customer order is assigned to the vehicle. Otherwise, an attempt will be made to match the forecasts, firm orders or assumptions with the customer preference.

As viewed by a dealer, initially only the dealer's own assumptions (or firm orders) are compared with the customer preference. If no assumption applies, then the dealer can search in the released assumption inventory of a neighboring dealer and attempt to satisfy the customer preference. This process of matching a customer with a neighboring dealer is referred to as “locating.”

The program block “Assumption Manipulator” performs the entire aforedescribed process of matching inventory or assumptions to customer orders and locating, and updates the various assumptions of the dealers.

The Firm Order Manipulator provides and/or outputs updated assumptions matched with customer order is as well as customer orders with allocated inventory or vehicles specified in the firm orders or assumptions.

Program Block “Daily Program”

This program block operates with the daily assumptions of the dealers. Depending on factory-specific requirements, for example the latest possible starting point for assembly, the assumptions are combined into daily programs. In addition, the vehicles specified in the assumptions are separated into modules. This is transmitted to the suppliers as defined quantities ready for release.

Outputs of the program block “Daily Program” are daily production programs for the factories as well as defined release quantities, which are transmitted to the suppliers.

Program Block “Production And Suppliers”

In this program block, the individual production sites, the factories of the suppliers and the times for assembly and delivery are modeled in abstract form by several model components

Average cycle times and cycle time variations as well as daily production capacities for the production sites and the suppliers' factories are defined as parameters.

In addition, the model elements include feature descriptions, for example through capacity limits, work time models, permanent staffing or other specific characteristics of the factories required for forecasting and planning processes of the aforedescribed program blocks.

The production facilities modeled in approximate model components provide simplified JIT (just-in-time) delivery schedules to the model components modeling the supply.

The daily programs form the input for this program block. The program block generates vehicles in the model which are transferred to the subsequent program block “Distribution.”

Program Block “Distribution”

Like the production sites or the factories of the suppliers, the distribution to the dealers or directly to the buyers is represented in abstract model elements which model the average distribution times. The conceptual phase defines the extent to which the capacity utilization of individual transport capacities must be considered.

Configuration of an Exemplary Basic Model

In the following, a basic model will be described in more detail. This basic model models an exemplary start of vehicle series production and the following year (for example the year 2003) without disruptions, such as strikes or supplier bottlenecks.

The model will be used to describe the markets U.S.A., Canada, Western Europe and a market which supplies the other regions.

The markets U.S.A. and Canada include the PPC's listed in FIGS. 26a and 26b. The markets Western Europe and “other areas” are each represented by an importer with a 100% market share.

An equipment variant A is sold in the European market. The equipment variants B, C, and D are sold in the other markets U.S.A., Canada and “other areas.”

The vehicle configuration includes the modeled vehicle classes and equipment.

A vehicle is described in the described model by a corresponding PR number family:
engine,
transmission,
climate control,
radio, and
roof.

Each vehicle has in addition an exterior paint color.

The various PR number families are structured, for example, as indicated in FIGS. 27a and 27b.

The product tree consists of a description of the basic vehicle, a vehicle type “vehicle X, U.S.”, commonalities in the equipment B, C, and D, a vehicle type “vehicle X, Europe” and equipment variants A, B, C, and D (see FIG. 28).

The following restrictions and exclusions have also been defined for these vehicle types:
1.6 liter engine, always with manual gear shift,
equipment variant B always with 2.0 l engine,
equipment variant C never with 1.4 l engine,
equipment variant C never with 1.4 l engine
equipment variant D always with 2.0 l engine.

The sales figures depicted in FIG. 29 were forecast for the vehicle X for the years 2002 and 2003 (start of series production and the following year). It was also assumed that production of vehicle X would start, for example, in calendar week (KW) KW 31, with the sales volume indicated in FIG. 30. These sales figures were initially divided in the model over the two vehicle types “vehicle X, U.S.” and “vehicle X, Europe.” The curve shape for the corresponding proportionate vehicle sales is indicated in FIGS. 31a and 31b.

The vehicle type “vehicle X, Europe” and the subordinate vehicle type A are 100% sold in the European market. The vehicle type “vehicle X, U.S.” and the subordinate vehicle type B, C, and D are sold in the markets U.S.A., Canada and “other areas” with the distribution shown in FIGS. 32a and 32b.

The following constant distribution is assumed for the equipment variants B, C and D:
B: 10% of the sales ofthe vehicle type “vehicle X, U.S.”,
C: 65% of the sales of the vehicle type “vehicle X, U.S.”,
D: 15% of the sales of the vehicle type “vehicle X, U.S.”

The production capacity was defined by assuming that factory A (outside Europe) operates in two seven-hour shifts from Mondays through Fridays and in a single seven-hour shift on Saturdays and that no work is performed on the days indicated in FIG. 33 work-free (holidays or scheduled plant shutdowns).

The proportionate factory output in the model was adjusted to produce an average factory utilization in the model of 85% for the vehicle X.

The distribution was modeled as follows:
vehicles destined for Europe are first transported to the port “Overseas” (duration approximately one week), from where the vehicles are transported by ship to the destination port (duration approximately three weeks). At the destination port, the vehicles are then stored for approximately one week. The distribution within Europe is not considered.
U.S. distribution
vehicles delivered to the markets “other areas” are shipped, for example, to Latin America (duration approximately three weeks).

The model assumes that transports occur daily. The capacity of the transport can optionally be limited.

The following parameters are assumed for process control:
FUI (factory allocation): 28 calendar days before ZP8,
daily breakdown (distributing the orders over days): 28 calendar days before ZP8,
FU2 (handover to production): 14 calendar days before ZP8,
FU1 and FU2 occur weekly,
forecasts are produced monthly,
volume agreements are generated monthly.
dealer orders are generated weekly.

When generating the daily program, the probability distribution of FIG. 34 is used for mixing the arrangement of the orders.

The basic model parameterized in that way provides (without further modifications) the results illustrated in FIGS. 35 to 42 for:
average, minimal and maximal delivery time: FIG. 35,
average delivery cycle time and order cycle time: FIG. 36,
delivery time for vehicles within certain engine: FIG. 37,
planning reliability: FIG. 38,
weekly program reliability: FIG. 39,
ZP8 reliability: FIG. 40,
delivery reliability: FIG. 41,
inventory: FIG. 42.

Different scenarios can be established based on this basic model.

For example, scenario S3 is characterized by an overly pessimistic sales forecast.

The basic model assumes that the predicted sales will indeed arrive as actual sales. This assumption is discarded in a scenario S3, which gives an overly pessimistic estimate of the sales volume. The effect of an overly pessimistic sales forecast on the process is then investigated.

For example, the model for the scenario S3 can be enhanced by assuming that the actual sales exceed the forecast sales by total of 20%.

For example, scenario S4 is characterized by an overly optimistic sales forecast.

In analogy to scenario S3, the effects of an overly optimistic forecast on the process can be investigated by assuming, for example, that the predicted sales volume is are altogether 20% higher than the actual sales.

Another scenario S5 models, for example, the effects of a strike stopping production.

For example, the strike begins on Mar. 1, 2003 and lasts a total of ten days. Two variants can be investigated. In the first variant, the effects of the strike are investigated when no counteractive measures are taken. In a second variant, the number of planned orders is reduced early on, because the strike was announced ahead of time.

Additional counteractive measures can be considered in expanded models.

In the described embodiment, the strike is modeled by a disturbance of the factory capacity.

Variant one: the strike occurs without taking counteractive measures.

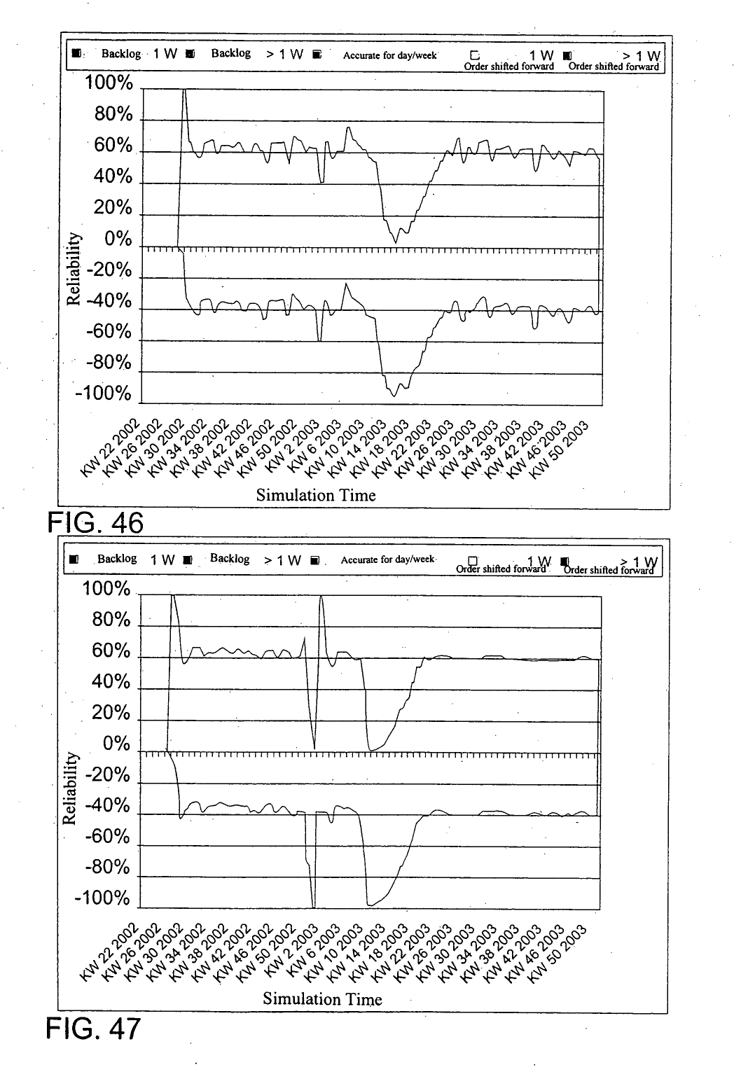

The simulated results for this variant are shown in FIGS. 43 to 49 for:
average delivery cycle time and order cycle time: FIG. 43,
delivery time for vehicles within certain engine: FIG. 44,
planning reliability: FIG. 45,
weekly program reliability: FIG. 46,
ZP8 reliability: FIG. 47,
delivery reliability: FIG. 48,
inventory: FIG. 49.

Variant two: after ten days, 1165 vehicles are delayed. In response to the strike, the targeted delivery for March is reduced in the simulation by 1165 vehicles.

The simulated results for this variant are shown in FIGS. 50 to 56 for:
average delivery cycle time and order cycle time: FIG. 50,
delivery time for vehicles within certain engine: FIG. 51,
planning reliability: FIG. 52,
weekly program reliability: FIG. 53,
ZP8 reliability: FIG. 54,
delivery reliability: FIG. 55,
inventory: FIG. 56.

In another scenario S6, for example, a bottleneck in the delivery of the diesel engines can be investigated with a simulation.

The model is hereby expanded, for example, by adding one additional supplier for this engine, and the capacity is adjusted so that the demand for engines can be exactly met. The bottleneck is then modeled as an interruption of the supplier's capacity.

The invention is not limited to the aforedescribed preferred exemplary embodiments. Instead, a number of variations and modifications which employ other embodiments are feasible, without deviating from the scope of the arrangement and process of the invention.

1. Method for simulating order processing processes used for producing a complex product, in particular a motor vehicle, characterized by the following steps:
a) entering into a data processing device demand quantities for at least one class of the product for at least one predefined period of time,
b) automatically adjusting, through use of a computer program installed on the data processing device, the demand quantities with predefined datasets that describe manufacturing capacities and/or (manufacturing) supplier capacities,
c) automatically allocating the demand quantities or portions of the demand quantities to production sites (factories),
d) simulating the production and/or supply for the production based on the allocation in step c),
e) automatically determining the distribution channels and simulating the distribution(s) of the finished products from the factories to the delivery locations,
f) storing and/or outputting at least a portion of the data generated in steps a) through e).

2. Method according to claim 1, characterized in that the data sets used in the automatic adjustment of the demand quantities in step b) include restrictions with respect to the production sites and/or suppliers.

3. Method according to claim 1, characterized in that the demand quantities in step a) of claim 1 are determined by
defining a first demand forecast for a first forecast time period,
determining a second demand forecast for a second forecast time period by using stochastic processes derived from the first forecast, and
determining the demand quantities according to defined algorithms which evaluate the first and/or second demand forecasts.

4. Method according to claim 1, characterized in that the automatic adjustment in step b) of claim 1 includes a correction of the demand quantities so as to match the demand quantities to the manufacturing capacities and/or (manufacturing) supplier capacities.

5. Method according to claim 1, characterized in that the process steps a) to c) of claim 1 include the following steps:
defining preliminary demand numbers (demand forecast) for a first forecast time period, preferably for a year of sales,
generating by simulation dealer orders for a second forecast time period, preferably for three months,
evaluating the preliminary demand numbers and dealer orders and determining an updated demand forecast for the second demand time period,
matching the updated demand forecast for the second demand time period to the capacities of the production sites and/or the suppliers, and determining approved firm order allocations and/or modular allocations,
generating the demand numbers (assumptions) for the defined time period, preferably a delivery week, by evaluating the approved firm order allocations, modular allocations and/or simulated buyer orders newly received by the dealers,
adjusting these demand numbers (firm orders) with respect to restrictions (capacity, utilization and the like) of the production site(s) and/or suppliers, and allocating the demand numbers (assumptions) to the production site(s).

6. Method according to claim 1, characterized in that the demand numbers for the defined time period are distributed over the daily assumptions, when the demand numbers are automatically allocated to the production sites.

7. Method according to claim 1, characterized in that the automatic allocation of the demand numbers to the production sites includes compiling daily schedules for the production sites.

8. Method according to claim 6, characterized in that the automatic allocation of the demand numbers to the production sites includes breaking up the products specified in the daily assumptions into their modules.

9. Method according to claim 1, characterized in that the demand numbers include information about significant equipment features of the products (“heavy items”).

10. Method according to claim 1, characterized in that the model on which the simulation is based models several production sites.

11. Method according to claim 1, characterized in that the model on which the simulation is based, includes parameters characterizing a production site, such as
capacity limitations,
work schedule models, and/or
permanent staffing.

12. Method according to claim 1, characterized in that in the model on which the simulation is based, a differentiation is made between dealers, in particular between dealers of the domestic market and importers.

13. Method according to claim 1, characterized in that in the model on which the simulation is based distribution, distribution channels are subdivided into distribution sub-channels.

14. Method according to claim 1, characterized in that the data generated in steps a) to e) of claim 1 include
quantitative evaluations of process designs,
assessments of strategies, for example with respect to managing disruptions,
times for freezing orders,
delivery times,
delivery reliability,
utilization of transportation means and/or
costs.

15. Method according to claims 1, characterized in that data from databases of real systems, in particular from databases of dealers and/or production sites, are automatically evaluated during the process.

16. Simulation system, which includes the modules “forecast”, “firm orders”, “assumptions”, “production”, and “distribution”, wherein the modules cooperate under the control of a computer program implemented on a computer system so that the following steps can be performed:
a) entering into a data processing device demand quantities for at least one class of the product for at least one predefined period of time,
b) automatically adjusting, through use of a computer program installed on the data processing device, the demand quantities with predefined datasets that describe manufacturing capacities and/or (manufacturing) supplier capacities,
c) automatically allocating the demand quantities or portions of the demand quantities to production sites (factories),
d) simulating the production and/or supply for the production based on the allocation in step c),
e) automatically determining the distribution channels and simulating the distribution(s) of the finished products from the factories to the delivery locations,
f) storing and/or outputting at least a portion of the data generated in steps a) through e).

17. Simulation system according to claim 16, characterized in that the simulation system includes interfaces to databases of real systems, such as the databases of dealers and/or production sites.

18. Computer program product with a computer-readable storage medium for storing a program which enables a computer, after the program is loaded into the memory of the computer, to execute a process for simulating order processing processes for producing a complex product, in particular a motor vehicle, wherein the simulation includes the process steps according to claim 1.

19. Computer-readable storage medium for storing a program which enables a computer, after the program is loaded into the memory of the computer, to execute a process for simulating order processing processes for producing a complex product, in particular a motor vehicle, wherein the simulation includes the process steps according to claim 1.

20. (canceled)

21. (canceled)
